(19) United States
(12) Patent Application Publication
(10) Pub. No.: US 2024/0335780 A1
(43) Pub. Date: Oct. 10, 2024

(54) PASSIVATION DEVICE, FILTER SYSTEM, DEVICE FOR THE ADDITIVE MANUFACTURING OF THREE-DIMENSIONAL OBJECTS, METHOD FOR PASSIVATING AND METHOD FOR FILTERING

(71) Applicant: EOS GMBH ELECTRO OPTICAL SYSTEMS, Krailling (DE)

(72) Inventors: Ulrich KLEINHANS, Prittriching (DE); Philip STRÖBEL, Weidenbach (DE); Fatime IMETOVSKA, Erding (DE)

(21) Appl. No.: 18/292,888

(22) PCT Filed: May 31, 2022
(86) PCT No.: PCT/EP2022/064732

§ 371 Date: Jan. 26, 2024

(30) Foreign Application Priority Data
Jul. 27, 2021 (DE) 102021208113.4

(51) Int. Cl. B01D 46/00; B01D 46/86; B22F 10/77; B33Y 40/00

(52) U.S. Cl. CPC B01D 46/0093; B01D 46/86; B22F 10/77; B33Y 40/00

(57) ABSTRACT

Disclosed is a passivation device for passivating a filter residue occurring in a filter device. The passivation device includes an outlet region for receiving filter residue from the filter device, a fluid supply for supplying a fluid flow of a fluid, which can include a passivating agent, into the outlet region, a fluid discharge for discharging the fluid flow and the filter residue from the outlet region and an energy supply device for applying energy to the fluid flow and/or the filter residue. The passivation device is configured and/or controllable to effect a chemical reaction between the filter residue and the passivating agent at least partially in the entrained flow. Furthermore, the passivation device optionally includes a passivating agent supply for adding a passivating agent to the fluid flow.

The present invention relates to a passivation device, a filter system comprising such a passivation device, a device for additive manufacturing of three-dimensional objects comprising such a filter system, a method for passivating a filter residue occurring in a filter device, and a method for filtering a process gas.

Devices and processes for the additive manufacturing of three-dimensional objects are used, for example, in processes known as “rapid prototyping”, “rapid tooling” and “additive manufacturing”. An example of such a process is known as “selective laser sintering” or “selective laser melting”. Here, a layer of a generally pulverulent building material is repeatedly applied and the building material in each layer is selectively solidified by selectively irradiating points corresponding to the cross-section of the object to be produced in this layer with a laser beam, for example by partially or completely melting the building material at these points using the energy provided by the laser beam and the melt then solidifies during cooling. Further details are described, for example, in EP 2 978 589 B1.

During the manufacturing process, a process gas atmosphere is often maintained in the process chamber in which the building material is selectively treated using radiation. The process gas atmosphere is usually an inert gas atmosphere (also known as a “protective gas atmosphere”), as some building materials, especially if they contain metal, tend to oxidize at the high temperatures that occur, which would prevent the formation of objects or at least prevent the formation of objects with the desired material structure. For example, titanium could start to burn uncontrollably in the presence of oxygen. In doing so, as a rule, a process gas flow is directed across the build plane, i.e. the surface of a layer of building material to be solidified.

During the process, part of the building material is often vaporized as a result of the irradiation, which leads to the formation of condensates after the resulting vapours have re-solidified. Furthermore, a part of the building material is often whirled up during the process. In addition, spatter can form during the process. These are often EP 2341/DH/SN/Dec. 18, 2023 solidified droplets of the molten building material with a diameter of between 20 and 300 μm, for example. Spatter is ejected from the resulting melt or melt pool when the laser grooves in, for example. Such spatter can also contaminate the process gas. Due to the condensates and/or the whirled-up building material and/or the spatter and/or other impurities carried along by the process gas in the form of particles or droplets, it is necessary to free the process gas from these undesirable impurities. This is particularly the case if the process gas is circulated, i.e. if it is to be reintroduced into the process chamber after it has left the process chamber and been filtered. Such a gas cycle is sometimes also referred to as “circulation” or “recirculated air”, the latter even if the process gas is not air. These unwanted impurities are often condensate particles, which condense out of the metal vapor during cooling and usually have a primary particle size of, for example, 20 nm to 50 nm and which can be combined to form larger agglomerates, and/or pulverulent building material with particle sizes between, for example, 1 and 50 μm. In US 2014/0287080, it is described that a closed gas flow circuit is provided for this purpose, with which a gas flow is guided through the process chamber of a selective laser melting device, wherein two filter devices are arranged in the gas flow circuit, each of which has a filter element.

DE 10 2014 207 160 A1 describes a cyclical cleaning of a filter element of a recirculating filter device by means of a gas pressure surge.

Particularly when metal-containing or metallic building materials (e.g. titanium or titanium alloys) are used, the particles tend to react with oxidative materials at high temperatures, wherein the reaction rate is increased at high temperatures. Metal condensate can spontaneously self-ignite at room temperature and in contact with atmospheric oxygen, i.e. it is generally pyrophoric. This can lead to uncontrolled filter fires or dust explosions, particularly in the area of filter elements where the particles carried along in the process gas accumulate. This risk is increased if oxygen reaches the filter element spontaneously (i.e. too quickly and/or in too large a quantity) when the filter element is changed. If, for example, the filter chamber is opened quickly, there may suddenly be so much oxygen in the filter chamber that the filter residue is oxidized and the reaction heat released in the process further increases the speed of oxidation. In such cases, the reaction may proceed in an uncontrolled way and a fire (filter fire) may occur.

EP 1 527 807 A1 describes an inerting process for separating dust components from an explosive dust-air mixture by using additive particles as an inerting agent with which the filter plates used are loaded. The quantity of additive particles is selected in such a way that the mixture of these particles with an introduced dust possibly does not constitute a combustible mixture, at least until an upper filling level of a dust container is reached. Calcium carbonate particles and silicon dioxide particles are mentioned as additive particles in conjunction with aluminum dust. The use of additional particles, in addition to their provision and costs, also means that the upper filling level is reached more quickly, so that the dust container has to be emptied more often. The additive particles can also be referred to as “filter auxiliary agent”.

DE 10 2017 207 415 A1 describes the treatment of particles that have been separated from a filter element in a separate treatment chamber outside the filter chamber. Therein, the formation of superficial oxide layers on the particles by adding oxygen to the treatment chamber in which the particles are located is described.

The object of the present invention is to provide an alternative or improved passivation device or an alternative or improved filter system or an alternative or improved device for the additive manufacturing of three-dimensional objects or an alternative or improved method for passivating a filter residue occurring in a filter device or an alternative or improved method for filtering a process gas.

This object is solved by the passivation device according to claim 1, the filter system according to claim 11, the device for additive manufacturing of three-dimensional objects according to claim 19, the system for additive manufacturing of three-dimensional objects according to claim 20, the method according to claim 21 and the method according to claim 26. Further developments of the invention are given in the dependent claims. Here, the methods can also be further developed by the features of the devices given in the description below and in the dependent claims. Conversely, the devices can also be further developed by the features of the method given in the description below and in the dependent claims. Furthermore, the features given in the description below and in the dependent claims for an independent claim can also be used to further develop the subject-matter of the further independent claims.

The passivation device according to the invention is a passivation device for passivating a filter residue occurring in a filter device. The passivation device according to the invention comprises an outlet region that can be coupled or is coupled directly or indirectly to the filter device and that is configured to receive filter residue from the filter device. The passivation device according to the invention further comprises a fluid supply for supplying a fluid flow of a fluid, which can comprise a passivating agent, into the outlet region. The passivation device according to the invention further comprises a fluid discharge for discharging the fluid flow and the filter residue from the outlet region. The passivation device according to the invention further comprises an energy supply device for supplying energy to the fluid flow and/or the filter residue. Furthermore, the passivation device optionally comprises a passivating agent supply for adding a passivating agent to the fluid flow.

The passivation device according to the invention is configured and/or controllable to effect a chemical reaction between the filter residue and the passivating agent at least partially in the entrained flow.

According to the invention, the filter device can be, or is, directly and/or indirectly coupled to the outlet region. In this context, the term “indirect coupling” is used if an intermediate chamber, a connecting line, a pipe or the like is provided between the filter device and the outlet region. An intermediate chamber or a connecting line is a chamber or line that is arranged between the filter device and the outlet region so that, for example, filter residue must pass through the intermediate chamber or connecting line in order to get from the filter device to the outlet region. Conversely, a “direct coupling” is present if there is no intermediate chamber and connecting line. Here, the filter device is preferably detachably coupled or connectable to the outlet region. This means that the coupled components can be separated again.

This region is referred to as the “outlet region” because it is the region of the passivation device into which the filter residue exiting the filter device first passes before it is conveyed further through the fluid discharge with the fluid flow.

By applying energy to the fluid flow and/or to the filter residue in accordance with the invention, e.g. in the form of thermal energy, a reaction between the filter residue and the passivating agent is accelerated or effected, for example. For example, chemical reactions often take place faster at elevated temperatures or the activation energy barrier can often be overcome by elevated temperatures, so that the chemical reaction starts in the first place due to the application of energy. Particularly in cases where mass transfer (e.g. supply of passivating agent) is not the limiting factor, the reaction rate can increase exponentially with temperature, for example.

As an alternative or in addition to a chemically reactive passivating agent such as an oxidizing agent, substances that are effective in another way can also be used to reduce the risk of fire. The use of filter auxiliary agents is discussed in detail below. Additionally or alternatively, for example, a liquid such as an oil (e.g. silicone oil) can be used to wet the filter residue and thus protect it from unwanted oxygen ingress. Such a liquid can, for example, be added to the filter residue in the waste container.

In this context, it should be mentioned that the filter residue is usually indirectly energized when energy is supplied to the fluid flow and vice versa. For example, a relatively rapid thermal equilibration takes place between the particles of the filter residue and the fluid of the fluid flow with which the particles are in contact, particularly in the case of small particles. This means, for example, that the filter residue is heated by the fluid flow if only the fluid flow is actively heated, for example by the heating taking place before the fluid flow enters the outlet region.

The passivation device according to the invention is configured and/or controllable to effect a chemical reaction between the filter residue and the passivating agent at least partially in the entrained flow. In this context, the term “partially” means that the chemical reaction need not only take place in the entrained flow, but can also take place in part when the filter residue and the passivating agent are not yet or no longer in the state of an entrained flow. For example, the chemical reaction can continue, at least to a certain extent, after the filter residue has been transported to a catchment by means of the fluid flow, i.e. in the entrained flow. Furthermore, the chemical reaction does not have to be complete, i.e. the filter residue does not have to be completely chemically converted by the passivating agent. For example, it may be sufficient if the particles of the filter residue form a superficial passivation layer as a result of the chemical reaction. Such a passivation layer can, for example, serve as a protective layer and prevent the particles from being oxidized on contact with oxygen. For example, an oxide layer specifically created by means of passivation can prevent titanium particles from reacting unintentionally on contact with oxygen or air.

An entrained flow is a two-phase flow consisting of a fluid and a particulate solid, i.e. a flowing aerosol. The contact between the fluid and the solid and the movement can, for example, enable an intensive and rapid exchange of substances and/or heat. This in turn can, for example, accelerate the desired chemical reaction or make it possible in the first place.

According to the invention, the use of a fluid flow is thus provided for three purposes in a combined manner: Firstly, the fluid flow serves to convey the filter residue from the outlet region where, it exits the filter device, through the conveying line. This allows the filter residue to be transported, for example, to a catchment such as a waste container. Secondly, the fluid flow serves to generate an entrained flow, which accelerates the chemical reaction for passivation, for example. This allows the filter residue to exit the conveying line in a passivated state, for example. Thirdly, the passivating agent is contained in the fluid flow. This can, for example, simplify the passivation and thus the passivation device compared to a separate addition of passivating agent.

Intensive mixing in the entrained flow can also be particularly advantageous, for example, if a solid powder, such as lime powder and/or silicon dioxide powder (quartz powder) and/or glass powder is used as an inerting agent in addition to the passivating agent in order to reduce the combustibility and/or flammability of the filter residue. Glass powder proves to be advantageous in some cases because it melts at lower temperatures than quartz powder, for example, so that even at relatively low temperatures the filter residue can be at least partially covered with molten glass or solidified molten glass, which can lead to a reduction in the risk of fire.

The filter residue can be mechanically stressed by the entrained flow, for example, by the particles of the filter residue colliding with one another and/or against a wall and/or against particles of an inerting agent, for example. As a result, it may be possible, for example, for the filter residue particles to at least partially break up into smaller particles. In particular, agglomerates of primary particles that are relatively weakly bound to each other can be broken up in this way. Broken agglomerates can, for example, be easier to passivate than unbroken agglomerates. In particular inerting agents with sharp-edged particles can be suitable for this purpose.

Overall, the invention can, for example, achieve more effective passivation of the filter residue, thereby reducing or completely eliminating the risk of the waste igniting itself. This can, for example, enable safe removal of the waste or the container containing the waste.

In addition, conveying in the entrained flow can lead to homogenization and compaction of the waste produced, consisting of filter residue and possibly filter auxiliary agent, which can, for example, reduce the service life of a container for the waste.

Preferably, the fluid discharge of the passivation device according to the invention is designed as a conveying line. The conveying line preferably has an inner diameter of at least 2 mm and/or at most 60 mm at least in a region thereof. More preferably, the conveying line has an inner diameter of at least 10 mm and/or at most 50 mm, even more preferably at least 20 mm and/or at most 40 mm. The conveying line has the aforementioned inner diameters at least in a region of its length, but in particular along its entire length.

Preferably, the fluid discharge of the passivation device according to the invention is designed as a conveying line. Alternatively or in addition to the preferred minimum and maximum values of the inner diameter mentioned, the conveying line preferably has a length and an inner diameter averaged over the length, for which the ratio of length to averaged inner diameter is at least 30:1. More preferably, this ratio is at least 50:1, even more preferably at least 70:1, particularly preferably at least 100:1.

In the context of the present invention, the length of the conveying line is understood to be the length of the conveying line between its first end, which is connected to the outlet region and at which the fluid flow enters, and its second end, at which the fluid flow exits and which is connected, for example, to a catchment (see below).

In the context of the present invention, the inner diameter averaged over the length is understood to mean the mean inner diameter, i.e. the inner diameter arithmetically averaged over the entire length of the conveying line. If, for example, the inner diameter is constant over the entire length of the conveying line, e.g. because the conveying line is a cylindrical pipe, this constant inner diameter is equal to the average inner diameter.

If the conveying line is a conveying line with a non-circular clear cross-section, the inner diameter in the context of the present invention is understood to be the diameter of a circular area that has the same area as the clear cross-section of the conveying line.

With the inner diameter of the conveying line according to the invention, the fire protection behavior and/or the explosion protection behavior of the passivation device can be improved, for example, since the risk of an unintentional fire or an unintentional explosion propagating from one area of the passivation device through the conveying line into another area of the passivation device is reduced. At the same time, the conveying line has a sufficient diameter for effective conveying. In this way, for example, it is possible to prevent an unintentional filter fire in a coupled filter device from breaking through the conveying line and thus spreading. The underlying principle is similar to the principle of the maximum experimental safe gap.

The Maximum Experimental Safe Gap (MESG) for a specific gas mixture is a measure that is determined in a standardized procedure (international standard IEC (International Electrotechnical Commission) 60079-1). This determines the maximum width that a gap of 25 mm in length in a container of the gas may have in order to prevent ignition beyond (EN (European Standard) 60079-20-1). This measure is not directly applicable to the present invention. On the one hand, the standardized geometry of a 25 mm long gap does not correspond to the typical geometry of the cross-section of the conveying line. On the other hand, the fire and ignition properties of the fluid conveyed through the conveying line depend on the composition of the fluid and, in particular, on the nature (chemical composition, surface, particle size, etc.) and concentration of the filter residue conveyed by the conveying fluid. However, the principle underlying the measure of the maximum experimental safe gap is applicable to the present invention. It states that a relatively small cross-section of a pipe makes ignition out of the pipe, ignition into the pipe and ignition through the pipe more difficult or completely impossible.

With the ratio according to the invention between the length of the conveying line and the inner diameter of the conveying line averaged over the length of the conveying line, for example, a conveying line can be provided which corresponds to a sufficiently long entrained flow for effective passivation and with which the advantageous fire protection behavior and/or explosion protection behavior described above can be realized.

Preferably, the fluid discharge of the passivation device according to the invention is designed as a conveying line. Alternatively or in addition to the preferred dimensions of the conveying line mentioned, the passivation device is preferably configured and/or controllable such that a dwelling time of the filter residue in the conveying line is at least 0.1 s, more preferably at least 0.15 s, even more preferably at least 0.2 s and/or at most 0.5 s, more preferably at most 0.4 s, even more preferably at most 0.3 s. Here, the dwelling time in the conveying line is the time that a filter residue particle requires on average to be transported from the start to the end of the conveying line, in particular along the entire distance in the entrained flow. This, for example, gives the filter residue sufficient time to be exposed to energy and for the chemical reaction, preferably without making the conveying line unnecessarily long.

Preferably, the passivation device is designed to convey the filter residue exclusively by means of the fluid flow. Thus, for example, an additional mechanical conveying device such as a screw conveyor can be dispensed with.

Preferably, the passivation device is designed to convey the fluid flow at least in the area of the outlet region and of the fluid discharge without the influence of a turbomachine and without the influence of a piston machine. Here, a turbomachine is a machine for conveying a fluid by means of rotor blades, vanes, paddles or other driven components. By conveying in this area, in which the fluid flow is loaded with filter residue, without such a machine, the maintenance effort or the susceptibility to malfunctions of the passivation device can be reduced, for example, as devices with driven components in particular are sensitive to contamination with solids.

Preferably, the conveying of the filter residue in the fluid discharge is independent of gravity. Thus, for example, the fluid discharge can assume any orientation in the room, which is accompanied by improved flexibility in the structure of the passivation device, so that the passivation device can be arranged in a more space-saving manner, for example.

Preferably, the energy supply device is a heating device, in particular a heating device configured to heat the fluid flow as it flows through the heating device. By using a heating device, for example, energy can be provided in a form with which the passivation reaction can be effectively accelerated or initiated, since chemical reactions often take place faster at elevated temperatures or the activation energy barrier can often be overcome by elevated temperatures.

Preferably, the energy supply device is arranged so that the fluid flow is heated to a predefined minimum target temperature before it enters the outlet region. This allows, for example, to apply energy to the filter residue already when it comes into contact with the fluid flow, so that the reaction is accelerated or initiated at an early stage, thereby achieving a reaction time as long as possible and/or a conversion as high as possible.

Preferably, the energy supply device is configured and arranged to supply energy to at least one element selected from the group consisting of fluid supply, outlet region and fluid discharge in order to apply energy to the fluid flow. As a result, the energy supply device can, for example, be arranged at a location of the passivation device at which it effectively introduces energy to accelerate or initiate the desired chemical reaction.

Preferably, the fluid supply comprises a nozzle that is configured and/or arranged such that the fluid flow directed through the nozzle is accelerated such that a suction pressure is generated for conveying the filter residue from the filter device and a fluid optionally present in the filter device into the outlet region, the filter residue being conveyed with the fluid flow through the fluid discharge from the outlet region, wherein more preferably the nozzle is designed as an ejector nozzle or Venturi nozzle, and/or wherein more preferably the nozzle is configured to adjust a velocity and/or a diameter of the fluid flow passing through the nozzle. Such a suction nozzle can, for example, effectively transport the filter residue from the filter device into the passivation device. In doing so, an ejector nozzle, for example, can provide this suction effect. By adjusting the velocity of the fluid flow and/or the diameter of the fluid flow, the amount of filter residue that is sucked in per unit of time can be adjusted, for example.

In particular, an ejector is a jet pump in which the pumping effect is generated by the flow of a stream of conveying fluid (also referred to as “propellant medium”), so that another medium (also referred to as “suction medium”) is sucked in and conveyed. Here, the filter residue is included in the suction medium or is sucked in together with the suction medium in the form of a fluid from the first collecting region. The media are preferably mixed in the outlet region so that a corresponding mixture is conveyed through the conveying line.

The present invention is not limited to the use of an ejector, as illustrated by the following description of exemplary embodiments without an ejector. In these exemplary embodiments, it is possible, for example, for the filter residue to enter the outlet region by the action of gravity, where it is captured by a fluid flow and transported further, the fluid flow being generated, for example, by a blower. The use of an ejector has proven to be advantageous in many cases, for example because filter residue particles can be effectively broken up in the ejector or downstream of the ejector without the need for a separate device such as a cross-sectional constriction in the conveying line.

Preferably, the conveying line comprises a shut-off valve. This allows, for example, the conveying line to be shut off in a fluid-tight manner when a catchment connected to one end of the conveying line is disconnected so that no material can escape from the passivation device or enter the passivation device. More preferably, the shut-off valve is arranged in the region of the end of the conveying line that is connected or is connectable to a catchment.

Preferably, the conveying line is designed as a rigid line, more preferably as a metal pipe, even more preferably a metal pipe with a wall thickness of at least 0.5 mm, more preferably at least 1 mm, even more preferably at least 2 mm, particularly preferably at least 5 mm. For example, a rigid line, in particular a rigid line made of a metallic material such as a metal pipe, can provide sufficient stability. For example, a metal pipe can be sufficiently pressure-resistant.

Preferably, the conveying line is thermally insulated. For example, this allows the filter residue and the fluid in the conveying line to be kept at an elevated temperature, which can be desirable, for example, if the filter residue is to react chemically with the fluid, because an elevated temperature can lead to an acceleration of the chemical reaction (e.g. oxidation with oxygen contained in the fluid).

Preferably, the passivation device comprises a catchment for collecting passivated filter residue, wherein the catchment is in fluid connection with the outlet region via the conveying line that is free from a shut-off valve, or via the conveying line when the shut-off valve is open. For example, passivated filter residue can be collected in a catchment for subsequent further treatment or disposal. However, it is also conceivable that the chemical reaction for passivation continues in the catchment for at least a certain period of time. In the simplest case, a catchment is a container.

Preferably, the passivation device comprises a passivating agent supply for supplying the passivating agent. This allows, for example, the fluid that initially forms the fluid flow to be taken from a fluid reservoir that does not contain the passivating agent. For example, a commercially available pressurized gas cylinder filled with inert gas (e.g. argon or nitrogen) can be used for this purpose. Such a fluid can be mixed with the passivating agent by adding it later via the passivating agent supply. Here, it is further preferable if the amount of passivating agent added per time unit can be adjusted and/or controlled.

In particular, the passivating agent supply is configured and arranged to supply passivating agent to at least one element selected from the group consisting of fluid supply, outlet region and fluid discharge. This allows, for example, the passivating agent to be supplied at the location of the passivation device at which the passivating agent is required for the desired chemical reaction.

Preferably, the passivating agent is an oxidizing agent that is suitable for at least partially oxidizing the filter residue. In this way, for example, filter residues comprising a metal can be passivated and an undesired subsequent reaction with oxygen (e.g. air) can be avoided.

More preferably, the oxidizing agent comprises oxygen, and even more preferably the oxidizing agent is oxygen, with the passivating agent being supplied in particular in the form of a mixture of oxygen and an inert gas, in particular argon. By using oxygen, for example, an oxidizing agent can be used with which filter residues that tend to react spontaneously with air can be passivated.

In particular, oxygen is understood to mean O₂. However, the use of ozone is also possible. It is also possible to use oxidizing agents that contain oxygen in another form, for example peroxides such as hydrogen peroxide. Furthermore, the use of oxidizing agents that are not based on oxygen is possible within the scope of the present invention. Chlorine or a chlorine-based oxidizing agent is conceivable, for example. However, water, for example, can also act as an oxidizing agent with respect to correspondingly base metals.

In the context of the present invention, an inert substance (e.g. inert fluid, inert gas, etc.) is understood to be a substance which, under the relevant conditions, does not undergo any or at least no significant reaction with the filter residue. For example, nitrogen and/or argon can serve as an inert fluid (in the specific case, an inert gas).

Preferably, the passivation device further comprises a fluid reservoir containing a fluid, in particular a compressed gas storage containing a pressurized gas, wherein the fluid supply provides a fluid connection between the fluid reservoir and the outlet region, and wherein the fluid contained in the fluid reservoir at least partially comprises the passivating agent and/or wherein the passivating agent is at least partially fed into the fluid supply and/or the fluid discharge and/or the outlet region by a passivating agent supply from a passivating agent reservoir and/or in the form of air from the atmosphere. In this way, for example, a supply of fluid required for operation of the passivation device can be ensured.

It is further preferred that the fluid supply and the fluid reservoir and optionally the passivating agent reservoir are configured or adapted or controllable so that in the outlet region or a region of the fluid discharge, as a fluid flow a gas flow is present that consists of a mixture of inert gas, in particular argon, and O₂ with an adjustable O₂ content and/or with an O₂ content in a range of at least 0.01% by volume, more preferably at least 0.1% by volume, even more preferably at least 1% by volume and/or at most up to 20.8% by volume, more preferably at most 10% by volume, even more preferably at most 5% by volume and/or with an O₂ content below the limiting oxygen concentration, more preferably at least 1%, even more preferably at least 2%, in particular preferably at least 3% below the limiting oxygen concentration. By means of adjustability and/or controllability, for example, the oxygen content can be adjusted in such a way that effective oxidation can take place and the safety of the passivation device is nevertheless ensured.

The specified concentration ranges can, for example, provide a suitable reactive atmosphere in many cases.

The limiting oxygen concentration is the maximum oxygen concentration of an oxygen-containing gas mixture, of an oxygen-containing aerosol, etc. at which an explosion does not occur. In other words, the risk of explosion can be reduced or completely eliminated by falling below the limiting oxygen concentration. An explosion inside the filter device is undesirable for safety reasons. Thus, for example, controlled oxidation with oxygen can be carried out under safe conditions by falling below the limiting oxygen concentration. Furthermore, the risk of explosion can be reduced even in the event of a malfunction, for example.

Preferably, the fluid supply is connected to the filter chamber in such a way that at least a portion of the filtered process gas is conveyed into the outlet region, wherein more preferably the fluid supply comprises a turbomachine, in particular a blower. By conveying filtered process gas, i.e. clean gas, into the outlet region, for example, filtered process gas can be used as a fluid for generating the fluid flow, so that the provision of an additional fluid can be dispensed with or the requirement for additional fluid is reduced.

Preferably, the conveying line comprises at least one locally limited cross-sectional constriction, wherein more preferably an inner cross-sectional area of the conveying line in the region of the cross-sectional constriction is reduced by at least 25%, even more preferably at least 50%, particularly preferably at least 75% compared to an inner cross-sectional area upstream of the cross-sectional constriction. Such a cross-sectional constriction can, for example, lead to a local acceleration of the fluid flow and thus to additional mechanical stress on the filter residue. As a result, for example, the breaking up of filter residue particles into smaller particles can be enhanced.

The filter system according to the invention is a filter system which comprises:
a) at least one filter device, each comprising
   aa) at least one filter chamber,
   bb) at least one filter element arranged in the filter chamber and
   cc) optionally a collecting chamber coupled to the filter chamber, which can preferably be separated from the filter chamber in a fluid-tight manner by a shut-off device, and
b) at least one passivation device according to the invention that is directly or indirectly coupled to the at least one filter device or connected to the at least one filter device by a transport device for transporting the filter residue.

By such a system, for example, both filtering of a process gas, in particular the process gas of a device for the additive manufacturing of three-dimensional objects, and passivating the filter residues produced in the process can be implemented. In this context, “filtering a process gas” means that the process gas, which is contaminated with impurities that are not gaseous, is cleaned by at least partially separating these impurities. Process gas before filtering is generally also referred to as “raw gas”, while process gas after filtering is generally also referred to as “clean gas”.

Preferably, a passivation device of the system is assigned to several filter devices. This means, for example, that the capacity of the passivation device can be optimally utilized. Frequently, in cases in which exactly one passivation device is assigned to exactly one filter device, this passivation device is in operation less frequently or for a shorter time than the filter device. In such cases, a passivation device can be better utilized, for example, if it ensures the passivation of the filter residue from several filter devices.

In general, a filter device can comprise several filter chambers, in each of which at least one filter element is arranged. Several filter chambers of a filter device can be connected in parallel.

A passivation device can be assigned to a filter device with one or more filter chambers. A passivation device can also be assigned to several filter devices, each with one or more filter chambers.

Furthermore, a filter device can be used to filter the process gas of several devices for the additive manufacturing of three-dimensional objects. For example, the filter device can have several filter chambers, wherein at one point in time a filter chamber can be assigned to each device for the additive manufacturing of three-dimensional objects. In this case, the number of filter chambers is more preferably greater than the number of devices for the additive manufacturing of three-dimensional objects, so that, for example, only some of the filter chambers are currently filtering process gas at a given time, while for the other part cleaning the at least one filter element and/or passivating the filter residue can be carried out. An example of such an overall system for the additive manufacturing of three-dimensional objects could, for example, consist of three devices for the additive manufacturing of three-dimensional objects, a filter device with four filter chambers and a passivation device.

Furthermore, several filter devices, each having at least one filter chamber, can also be used for filtering the process gas of several devices for the additive manufacturing of three-dimensional objects, wherein at each point in time, a filter device can be assigned to each device for the additive manufacturing of three-dimensional objects. In this case, the number of filter devices is more preferably greater than the number of devices for the additive manufacturing of three-dimensional objects, so that, for example, only some of the filter devices are currently filtering process gas at a given point in time, while for the other part cleaning the at least one filter element and/or passivating the filter residue can be carried out. An example of such an overall system for the additive manufacturing of three-dimensional objects could, for example, consist of three devices for the additive manufacturing of three-dimensional objects, four filter devices and a passivation device.

Preferably, the filter chamber comprises a collecting region, wherein in an operating position, the collecting region is arranged below the at least one filter element. More preferably, the collecting region comprises a downwardly tapering wall and leads to a filter chamber outlet connected to the passivation device or the collecting chamber. Alternatively or in addition to the tapering of the wall, a conveying device for conveying filter residue is preferably provided at least in a subregion of the collecting region, in particular in a subregion with a lower inclination to the vertical as compared to to other subregions, wherein more preferably the conveying device comprises a solids fluidizing device, in particular a fluidizing plate, and/or one or more gas nozzles for introducing gas surges. By arranging the collecting region below the at least one filter element, for example, the cleaned filter residue can fall into the collecting region. The aforementioned tapering allows, for example, effective collecting and easy removal of the collected filter residue at the lowest point of the filter chamber. A solids fluidization device can, for example, ensure that filter residue that remains on the wall of the filter chamber slides downwards or is conveyed downwards.

Preferably, the filter chamber, in particular the collecting region, is configured such that the passivation device and a collecting chamber optionally comprised by the filter device can be arranged at least partially below the filter chamber in the operating position, wherein further preferably a catchment optionally comprised by the passivation device can be arranged at least partially below the filter chamber. This can, for example, enable a space-saving arrangement.

Preferably, the filter system comprises an application device for applying a filter auxiliary agent, in particular a filter auxiliary agent in powder form, to the at least one filter element. By using a filter auxiliary agent, filter residues can be inertized. Here, the use of a filter auxiliary agent can also be provided in addition to the use of a passivating agent such as an oxidizing agent (e.g. O₂). The use of a filter auxiliary agent can be particularly effective, for example, in combination with the entrained flow according to the invention, for example because the recirculation can enable good mixing of filter residue and filter auxiliary agent.

According to a non-limiting theory, the function of the filter auxiliary agent is to provide a thermal ballast and/or to spatially separate the filter residue particles from each other in order to slow down or moderate a chemical reaction of the filter residue. Glass powder, for example, can melt and the enthalpy of fusion extracts additional heat. Lime, for example, can decompose endothermically at approx. 800° C. This decomposition absorbs heat.

According to a non-limiting theory, a further function of the filter auxiliary agent is to improve filtration, for example in the sense that the filters need to be cleaned less frequently. The filter auxiliary agent could, for example, form a separating layer between the filter and the filtrate (filter cake), wherein it should be applied after cleaning for this purpose.

Preferably, the filter system comprises a filling level sensor for measuring a quantity of filter residue detached from the at least one filter element in the filter chamber, in particular in the collecting region and/or in the optional collecting chamber. The filling level sensor can be used, for example, to determine whether the passivation of filter residue according to the invention currently is to be carried out or whether it should be accelerated or slowed down.

In preferred exemplary embodiments, the filter system comprises exactly one filter device, wherein the passivation device is directly or indirectly coupled to the filter chamber or to the optional collecting chamber. Thus, for example, all of the filter residue to be passivated that accumulates in a filter device can be treated in a passivation device that is only provided for this purpose. Such a filter system can form a complete system together with a device for additive manufacturing of three-dimensional objects or together with several such devices. At any given point in time, the filter device can serve to filter the process gas of one or more devices for the additive manufacturing of three-dimensional objects.

In other preferred exemplary embodiments, the filter system comprises at least two filter devices and a transport device for transporting the filter residue from the at least two filter devices to the passivation device, wherein the transport device is further preferably a suction device. As a result, the number of passivation devices required can be reduced when operating several filter devices, for example. Such a filter system can form a complete system together with a device for additive manufacturing of three-dimensional objects or together with several such devices. The at least two filter devices can each serve to filter the process gas of one or more devices for the additive manufacturing of three-dimensional objects at a specific point in time. It is also possible for several filter devices to be used at the same time to filter the process gas of a device for the additive manufacturing of three-dimensional objects.

In other preferred exemplary embodiments, the filter system comprises at least two filter devices, wherein the passivation device is directly or indirectly coupled to one of the filter devices, and a transport device for transporting the filter residue from at least one other of the filter devices to the passivation device, wherein preferably the transport device is a suction device. As a result, the number of passivation devices required can be reduced when operating several filter devices, for example. Such a filter system can form a complete system together with a device for the additive manufacturing of three-dimensional objects or together with several such devices. The at least two filter devices can each serve to filter the process gas of one or more devices for the additive manufacturing of three-dimensional objects at a specific point in time. It is also possible for several filter devices to be used at the same time to filter the process gas of a device for the additive manufacturing of three-dimensional objects.

In other preferred exemplary embodiments, the filter system comprises at least two filter devices and a transport device for transporting the filter residue from at least one of the filter devices into the collecting chamber of at least one further filter device, the transport device preferably being a suction device. This allows the number of passivation devices required to be reduced when operating several filter devices, for example. Such a filter system can form a complete system together with a device for the additive manufacturing of three-dimensional objects or together with several such devices. The at least two filter devices can each serve to filter the process gas of one or more devices for the additive manufacturing of three-dimensional objects at a specific point in time. It is also possible for several filter devices to be used at the same time to filter the process gas of a device for the additive manufacturing of three-dimensional objects.

In the exemplary embodiments described above with at least two filter devices, the at least two filter devices are preferably assigned or can be assigned to different devices for the additive manufacturing of three-dimensional objects (e.g. different machines for selective laser sintering). This, for example, allows the number of passivation devices required to be reduced when operating several additive manufacturing devices.

In general, a filter system according to the invention can also comprise more than one passivation device.

According to the invention, the device for additive manufacturing of three-dimensional objects comprises:
a process chamber in which additive manufacturing takes place,
a process gas conveying device for conveying a process gas flowing through the process chamber from a process chamber inlet to a process chamber outlet, wherein the process gas conveying device is configured to effect the conveying between the process chamber inlet and the process chamber outlet preferably at least partially in a circuit,
a filter system according to the invention.

Here, the at least one filter chamber is arranged such that the process gas exiting the process chamber is filtered by the at least one filter element, respectively.

The additive manufacturing device according to the invention can, for example, provide a device during the operation of which, for example, the advantageous features of the filter system according to the invention or the passivation device according to the invention, which are described above, can be realized.

The passivation device according to the invention and the filter system according to the invention can be structured such that a conventional additive manufacturing device having a process chamber and a process gas conveying device can be retrofitted. If the conventional additive manufacturing device comprises a filter device, this can be replaced by the filter system according to the invention for retrofitting, for example. Alternatively, the passivation device according to the invention can be added, for example. Alternatively, the missing components can also be retrofitted, for example.

According to the invention, the system for additive manufacturing of three-dimensional objects comprises at least two devices for the additive manufacturing of three-dimensional objects, wherein the devices each comprise a process chamber in which the additive manufacturing takes place, and a process gas conveying device for conveying a process gas flowing through the process chamber from a process chamber inlet to a process chamber outlet, wherein each process gas conveying device is configured to effect the conveying between the process chamber inlet and the process chamber outlet preferably at least partially in a circuit. The system according to the invention for the additive manufacturing of three-dimensional objects further comprises a filter system according to the invention comprising at least two filter devices. This makes it possible, for example, to provide a system for the additive manufacturing of three-dimensional objects in which the number of passivation devices required is relatively low, in particular lower than the number of devices for the system for the additive manufacturing of three-dimensional objects.

Preferably, one of the at least two filter devices can be assigned or is assigned to each additive manufacturing device. More preferably, the number of filter devices in the system is greater, in particular by 1, than the number of devices for additive manufacturing.

An example of a system for the additive manufacturing of three-dimensional objects according to the invention could, for example, comprise three devices for the additive manufacturing of three-dimensional objects, four filter devices, each with a filter chamber, and a passivation device.

A system according to the invention for the additive manufacturing of three-dimensional objects can, for example, also comprise more than one passivation device.

According to the invention, the method for passivating a filter residue occurring in at least one filter device comprises the steps of:
supplying filter residue that exit the at least one filter device into an outlet region, in particular by suction,
supplying a fluid flow into the outlet region,
discharging the fluid flow loaded with the filter residue from the outlet region,
applying energy to the fluid flow, in particular heating of the fluid flow, wherein the application of energy to the fluid flow takes place before supplying and/or during the supply of the fluid flow into the outlet region and/or in the outlet region and/or during the discharge and/or after the discharge of the fluid flow from the outlet region.

The fluid flow used is a fluid flow of a fluid comprising a passivating agent. Alternatively or in addition, a passivating agent is added to the fluid flow.

In the course of the process, the filter residue is at least partially passivated by a chemical reaction with the passivating agent in the entrained flow.

Preferably, the fluid flow loaded with the filter residue either falls below the lower explosion limit, preferably reaching at most 0.9 times the lower explosion limit, more preferably at most 0.8 times the lower explosion limit. Or the fluid flow loaded with the filter residue preferably exceeds the upper explosion limit, wherein preferably at least 1.1 times, more preferably at least 1.2 times the upper explosion limit is reached.

Explosion limits are the limits of the so-called explosion range. The lower explosion limit and the upper explosion limit are the lower and upper limit value, respectively, of the concentration (e.g. mole fraction) of a flammable substance in a mixture of gases, vapors, mists and/or dusts in which a flame independent of the ignition source can no longer propagate independently after ignition.

By either falling below the lower explosion limit or exceeding the upper explosion limit, there exists no explosive mixture. This can, for example, improve safety when carrying out the passivation process according to the invention or the operation of a device used for this purpose by reducing the risk of explosion.

Preferably, the passivation results in at least 75%, more preferably at least 85%, even more preferably at least 95% complete chemical conversion of the filter residue particles.

Alternatively, a passivation layer, for example an oxide layer, is formed on the filter residue particles by the passivation, wherein the passivation layer has a layer thickness of at least 0.5 nm, preferably at least 0.75 nm, more preferably at least 1 nm and/or at most 10 nm, preferably at most 5 nm, more preferably at most 2 nm.

Preferably, the fluid flow is supplied into the outlet region in such a way that a suction pressure is generated in the outlet region, preferably by a nozzle, wherein the filter residue and a fluid optionally present in the at least one filter device are sucked into the outlet region from the at least one filter device by the suction pressure, and wherein the filter residue is conveyed out of the outlet region with the fluid flow through the fluid discharge, wherein more preferably a velocity and/or a diameter of the fluid flow passing through the nozzle are adjusted. By such a suction, for example, effective transport the filter residue from the filter device into the passivation device can be effected. An ejector nozzle, for example, can provide this suction effect. By adjusting the velocity of the fluid flow and/or the diameter of the fluid flow, for example, the amount of filter residue that is sucked in per unit of time can be adjusted.

Preferably, the fluid flow is adjusted and/or controlled such that particle agglomerates occurring in the filter residue are broken up, in particular such that the filter residue after breaking up is present in the form of particles having a secondary particle diameter that corresponds to a maximum 100-fold, more preferably maximum 50-fold, even more preferably maximum 10-fold, in particular preferably maximum 5-fold primary particle diameter and/or a secondary particle diameter of maximum 200 μm, preferably maximum 100 μm.

Preferably, in doing so, the break-up is effected directly or indirectly by the action of the fluid flow, i.e. in particular by the particle agglomerates and the fluid flow encountering each other and/or by impacts between the particle agglomerates and/or by impacts between the particle agglomerates and other particles (e.g. filter auxiliary agent particles) and/or by impacts of the particle agglomerates against a component of the passivation device, e.g. a wall.

Here, it is particularly preferred that particle agglomerates are broken up into the primary particles or into agglomerates of a few primary particles.

Such a break-up can, for example, promote passivation through a chemical reaction and/or mixing with an inerting agent (e.g. lime powder).

According to a non-limiting theory, metal condensates in particular have a very high specific surface area (e.g. 20 m²/g or even more) due to the small primary particles. The larger the specific surface area, the faster a reaction can generally take place, provided the surface is accessible to the reagent, such as oxygen as an oxidizing agent. The agglomerates—formed from small, in particular spherical primary particles—have small interspaces that are in the range of the mean free path of oxygen (68 nm at 20° C.). As a result, oxygen transport into the interior of agglomerates is strongly obstructed, for example Knudsen diffusion could occur. The obstruction of oxygen transport slows down the reaction. According to the non-limiting theory, breaking up the agglomerates exposes the surface better or makes the surface more accessible and thus increases the reaction rate. According to this theory, oxygen only has to diffuse through the boundary layer of the primary particles after breaking up agglomerates and not additionally through the narrow, twisted spaces between the agglomerates.

In the context of the present invention, the particle size or particle diameter is preferably understood to be the d50 value. Here, the d50 value can be determined for particles of the building material and for condensate particles or the primary particles contained therein, for example by means of laser diffraction according to the established and standardized methods (e.g. according to ISO 13320 or ASTM B822). Alternatively, determination is possible, for example, by means of dynamic image analysis (e.g. according to the ISO 13322-2 standard). The size of agglomerates can also be specified in the form of a d50 value. A specific d50 value means that 50% of the particles have a smaller diameter than the specified value. Suitable methods for determining the d50 value of agglomerates are, for example, transmission electron microscopy (TEM) and scanning electron microscopy (SEM), wherein the resulting images are subjected to suitable image evaluation to determine the d50 value.

If the conveying device has a nozzle such as an ejector nozzle or a Venturi nozzle, it may be possible for the break-up to take place in the nozzle or downstream of the nozzle. In addition to its function in conveying the filter residue, such a nozzle can therefore also have the function of reducing the filter residue particles to small particles.

If no such nozzle is used or if additional break-up is desired, a cross-sectional constriction of the conveying line can be provided.

Preferably, the fluid is discharged from the outlet region into a catchment by the fluid discharge. This allows the filter residue, for example, to be transported to a catchment and stored there until further processing or disposal.

Preferably, the chemical reaction takes place in the outlet region and/or during discharge, i.e. while the filter residue is being transported through the conveying line. In this way, for example, a fluid flow used for the purpose of transporting the filter residue into or out of the outlet region can be used to generate the entrained flow intended for the chemical passivation reaction without the need to generate a new corresponding fluid flow.

According to the invention, the method for filtering a process gas, in particular a process gas of a device for the additive manufacturing of three-dimensional objects, comprises the following steps:
optionally coating at least one filter element with a filter auxiliary agent, in particular with a filter auxiliary agent in powder form,
passing the process gas through the at least one filter element to filter out particles from the process gas,
cleaning the filter element or cleaning of at least a part of two or more than two filter elements from the filter residue formed from filtered-out particles and the optional filter auxiliary agent,
optionally collecting the filter residue and
passivating the filter residue according to the method for passivation according to the invention.

When carrying out the method for filtering a process gas, for example, a process gas can be purified and the resulting filter residue can be passivated, wherein the advantages of the passivation method described above can be realized.

Preferably, at least two filter elements are used to carry out the method for filtering a process gas, wherein the filter elements are cleaned at different times, wherein a waiting time is maintained between two successive cleaning processes and wherein the passivation step is at least partially carried out during the waiting time. This allows, for example, the portions of the filter residue resulting from a cleaning process to be reduced, while still maintaining continuous filtering of the process gas over a longer period of time. Here, the at least two filter elements are preferably arranged in different filter chambers. Further preferably, cleaning of different filter chambers is carried out at different times.

Further features and expediencies of the invention arise from the description of exemplary embodiments with reference to the accompanying drawings.

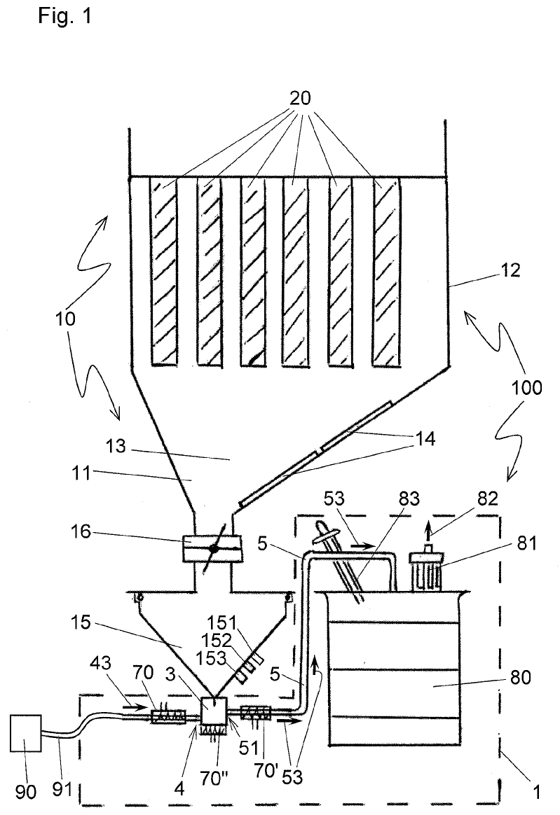

FIG. 1 is a schematic view, partially shown in cross-section, of a passivation device according to a first exemplary embodiment of the invention, which is coupled to a filter device.

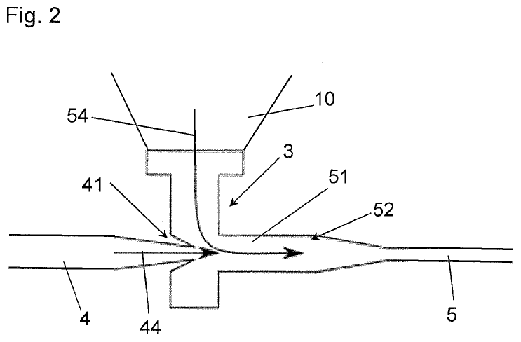

FIG. 2 is a schematic view in cross-section of a detail of the passivation device according to the first exemplary embodiment.

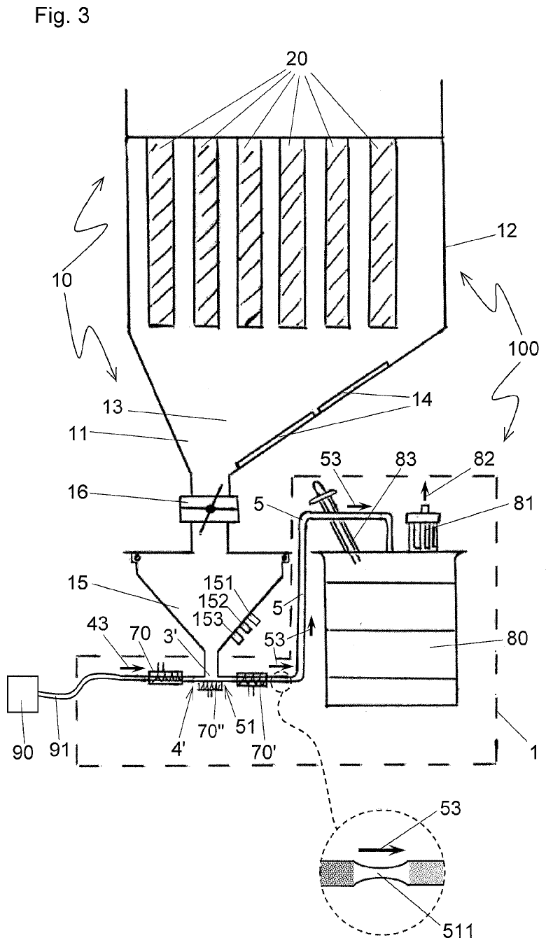

FIG. 3 is a schematic view, partially shown in cross-section, of a passivation device according to a second exemplary embodiment of the invention, which is coupled to a filter device.

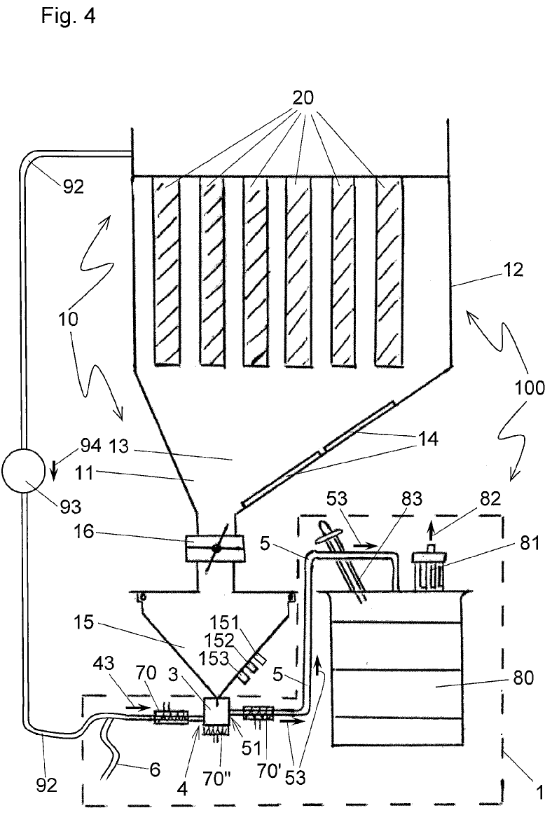

FIG. 4 is a schematic view, partially shown in cross-section, of a filter system according to a further exemplary embodiment of the invention.

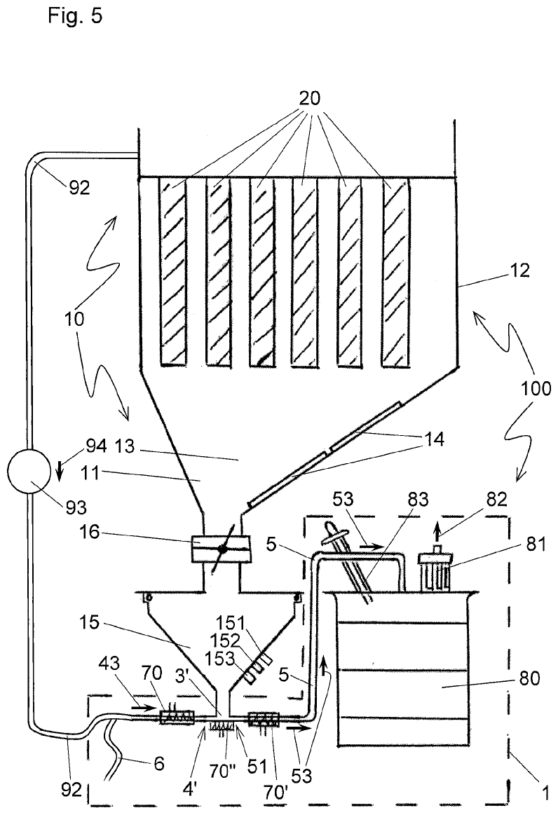

FIG. 5 is a schematic view, partially shown in cross-section, of a filter system according to a further exemplary embodiment of the invention.

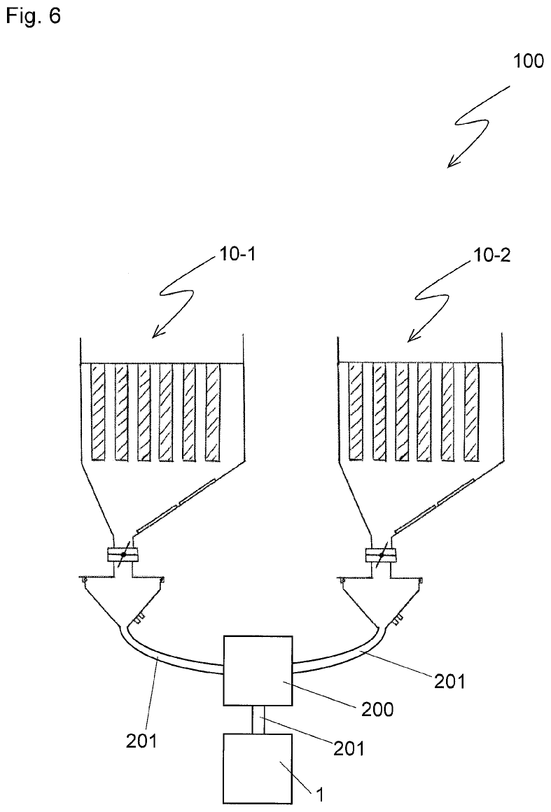

FIG. 6 is a schematic view, partially shown in cross-section, of a filter system according to a further exemplary embodiment of the invention.

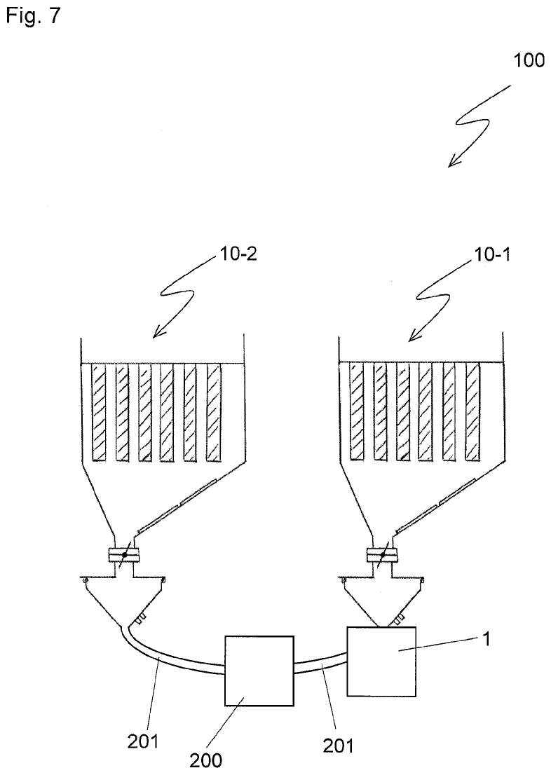

FIG. 7 is a schematic view, partially shown in cross-section, of a filter system according to a further exemplary embodiment of the invention.

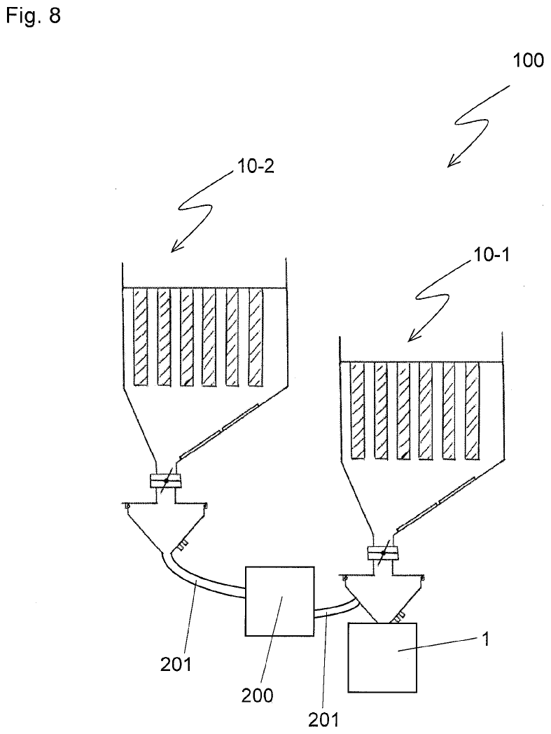

FIG. 8 is a schematic view, partially shown in cross-section, of a filter system according to a further exemplary embodiment of the invention.

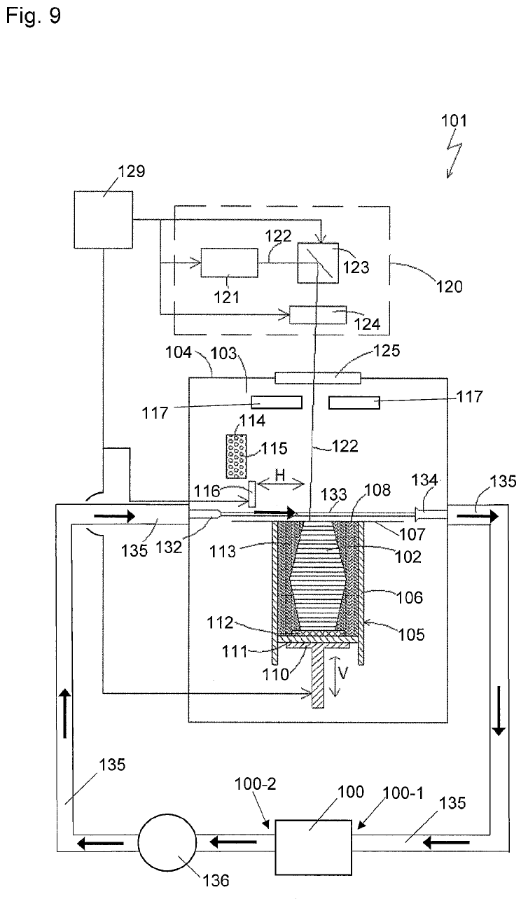

FIG. 9 is a schematic view, partially shown in cross-section, of a device for the additive manufacturing of three-dimensional objects according to further exemplary embodiments of the invention.

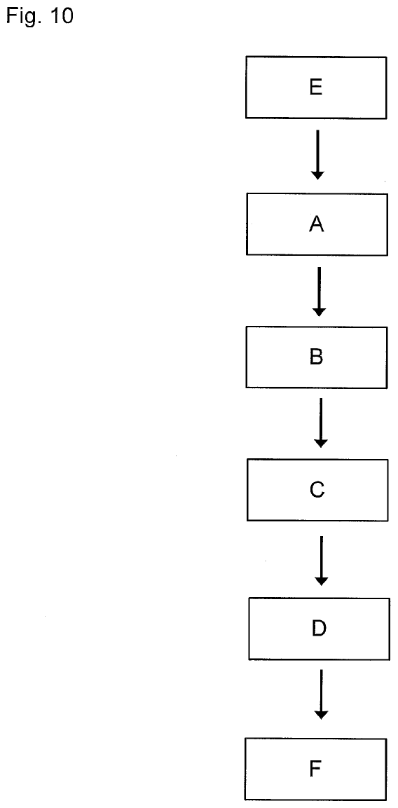

FIG. 10 is a schematic representation of the method for passivating a filter residue according to a further exemplary embodiment of the invention.

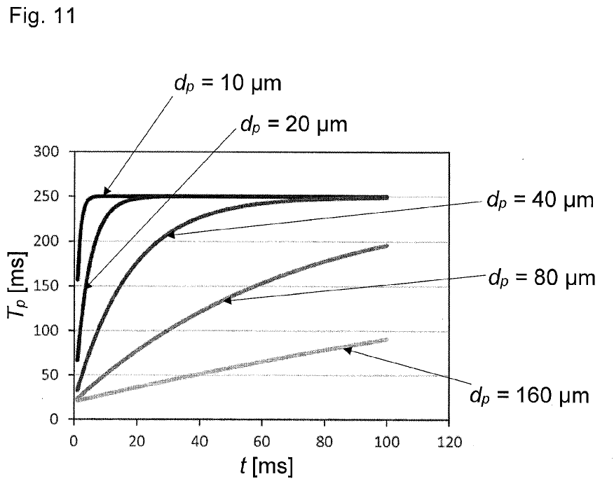

FIG. 11 is a diagram in which the heating of various particles in a gas atmosphere is shown as a function of time.

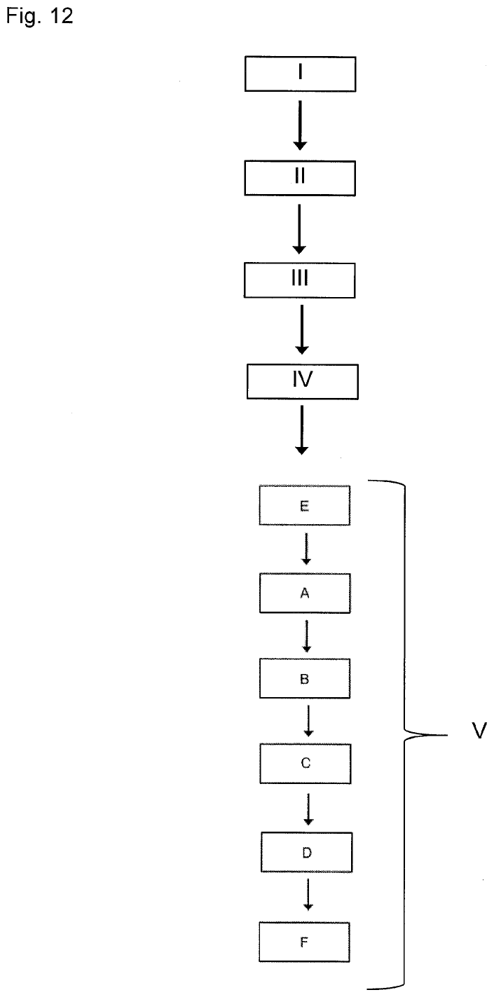

FIG. 12 is a schematic representation of the method for filtering a process gas according to a further exemplary embodiment of the invention.

### FIRST EXEMPLARY EMBODIMENT

The passivation device 1 according to the first exemplary embodiment is shown in FIG. 1 in a possible operating position. The passivation device 1 is coupled to a filter device 10. The passivation device 1 corresponds to the area framed with dashed lines in FIG. 1. FIG. 1 as a whole thus shows a filter system 100 according to the invention. The filter system 100 and the filter device 10 will be discussed in detail below. The filter device 10 is also shown in FIG. 1 in a possible operating position. This means that it is arranged such that, on the one hand, a process gas can be filtered by means of the filter device 10 and thereby cleaned of solids entrained in the process gas, and that, on the other hand, filter residue can exit the filter device 10 and enter the passivation device 1.

The position and direction designations used in the following description, such as “down”/“up”, “below”/“above”, “downwards”/“upwards”, etc., refer to the operating position shown.

As mentioned, the process gas can, for example, be the process gas of a device for the additive manufacturing of three-dimensional objects, such as a system for selective laser sintering. The solids that are carried along by the process gas can therefore be solids that can be provided to the process gas in such a device, in particular condensate particles formed from vaporized building material and/or whirled-up building material. These solids are at least partially separated from the process gas (raw gas) by the filter device and then form the filter residue.

The passivation device 1 comprises an outlet region 3, which can be coupled or is coupled to the filter device 10. FIG. 1 shows a situation in which the outlet region 3 is coupled to the filter device 10. The outlet region 3 is configured to receive filter residue from the filter device 10.

The passivation device 1 further comprises a fluid supply 4 for supplying a fluid flow into the outlet region 3. The fluid flow consists of a fluid comprising a passivating agent.

For example, the fluid consists of a mixture of an inert fluid and the passivating agent, which is also fluid. In particular, it can be a mixture of an inert gas with which the filter residue reacts chemically for passivation. Preferably, the chemical reaction is an oxidation reaction, more preferably an oxidation reaction with oxygen. In order to effect partial oxidation of the filter residue with oxygen, a mixture of oxygen and an inert gas (such as argon or nitrogen) can be used as the fluid, for example.

The fluid can, for example, be taken from a fluid reservoir 90 that is provided, e.g. a compressed gas storage in the form of a pressurized gas cylinder or the like. For this purpose, a fluid connection 91 is provided between the fluid supply 4 and the fluid reservoir 90.

A pressurized gas cylinder with an optional reducing valve is generally suitable for providing the fluid in the quantity and at the pressure required for a longer operating time. Instead of a pressurized gas cylinder, another container suitable for storing the fluid can be used as fluid reservoir 90, wherein, if necessary, a device for increasing or decreasing the fluid pressure and/or a device for adjusting and/or regulating the fluid pressure can be provided in addition to the container.

Alternatively, the fluid can be taken from several fluid reservoirs 90. For example, the inert fluid can be taken from one fluid reservoir and the passivating agent from another fluid reservoir, wherein the inert fluid and the passivating agent are mixed. If oxygen is provided as the passivating agent, it can also be used in the form of air from the ambient atmosphere, optionally after compression and/or filtering. In this case, the ambient atmosphere is understood as a fluid reservoir for the passivating agent. It is also possible for a fluid reservoir to contain a mixture of an inert fluid and the passivating agent and for further passivating agent to be added from another fluid reservoir, at least if necessary.

The amount of fluid entering the outlet region 3 per unit of time can preferably be adjusted and/or regulated by a regulating device (not shown in FIG. 1). The flow direction of the fluid flow through the fluid supply 4 is symbolized by the arrow 43 in FIG. 1.

The passivation device 1 optionally comprises a passivating agent supply (not shown in FIG. 1), through which the passivating agent is fed, for example, into the fluid supply and/or the fluid connection 91 between the fluid supply and a fluid reservoir 90.

The passivation device 1 comprises a fluid discharge 5 for discharging the fluid flow and the filter residue from the outlet region 3. The fluid discharge 5 is designed as a conveying line 5. The inner diameter of the conveying line 5 or the ratio between the length of the conveying line and its inner diameter has the values given above.

The flow direction of the flow of the fluid flow and the filter residue through the fluid discharge 5 is symbolized by the arrows 53 in FIG. 1.

Preferably, the conveying line 5 is designed as a rigid line at least in sections thereof, and more preferably comprises a metal pipe, in particular a metal pipe having a wall thickness of at least 2 mm.

Optionally, the conveying line 5 is thermally insulated, i.e. at least one section of the conveying line is optionally provided with an insulating device, for example an insulating casing.

Optionally, the fluid discharge 5 comprises a shut-off valve with which the fluid discharge 5 can be blocked for a fluid passage.

According to the first exemplary embodiment, the fluid supply 4 comprises a nozzle 41 through which the fluid flow enters the outlet region 3. When the fluid flow passes through the nozzle 41 into the outlet region 3, the fluid is accelerated through the nozzle 41. This generates a suction pressure in the outlet region 3, through which filter residue and any fluid in the filter device 10 are sucked and thus drawn into the outlet region 3. The filter residue sucked in from the filter device 10 and any from the filter device 10 are ejected from the outlet region 3 through the ejection region 51.

This configuration of the outlet region 3 with such a nozzle 41, which generates suction pressure, is often referred to as an “ejector”. Alternative terms include “jet ejector”, “eductor-jet pump” and “jet pump”. Such a nozzle 41 of an ejector is often referred to as an “ejector nozzle” or “motive fluid nozzle”.

FIG. 2 is a detailed view of a schematic view in cross-section of a specific example of the outlet region 3, the fluid supply 4 in the form of a nozzle 41 and the ejection region 51 according to the first exemplary embodiment, which are components of the ejector. The flow of the fluid flow flowing in through the nozzle 41 is symbolized by the arrow 44. The suction of filter residue and possibly fluid from the filter device 10 into the outlet region 3 and the conveying of the sucked-in filter residue and possibly the sucked-in fluid together with the fluid flow through the ejection region 51 and further through the fluid discharge 5 is symbolized by the arrow 54.

The passivation device 1 comprises an energy supply device 70 for applying energy to the fluid flow and/or the passivating agent and/or the filter residue. Preferably, the energy supply device 70 is a heating device. According to the first exemplary embodiment, the energy supply device 70 is configured and arranged to introduce energy into the region of the fluid supply. The positioning of the energy supply device 70 close to the outlet region 3 shown in FIG. 1 is merely exemplary. It can also be further away from the outlet region. In addition to the mentioned energy supply device 70, at least one further energy supply device 70′, 70″ can optionally be provided, for example in the region of the outlet region 3 and/or in the region of the conveying line. These possible arrangements are shown in FIG. 1.

Preferably, the energy supply device 70 is a heating device, in particular a continuous flow heater, i.e. a heating device that heats the fluid flow as it flows through the heating device or through the section of the conduit in which the heating device is arranged.

Optionally, the passivation device 1 comprises a catchment 80, which is in fluid connection with the outlet region 3 via the fluid discharge 5 if the fluid discharge does not comprise a shut-off valve or if an existing shut-off valve is open. Through the fluid connection, the fluid flow with the filter residue can be conveyed from the outlet region into the catchment and collected in the catchment. The filter residue can then be disposed together with the catchment, subjected to further treatment in the catchment or removed from the catchment for disposal or further treatment.

Such a catchment 80 preferably has a filter 81 through which the fluid entering the catchment 80 as a fluid flow can escape. The flow of the escaping fluid is symbolized by the arrow 82 in FIG. 1.

A filling level sensor 83 is preferably arranged in the region of such a catchment 80, with which the filling level of the catchment 80 can be monitored, in particular in order to determine the time at which the catchment 80 must be emptied or replaced by an empty catchment.

The passivation device 1 is configured and/or controllable to cause a chemical reaction between the filter residue and the passivating agent at least partially in the entrained flow. This means, firstly, that filter residue is drawn in by the ejector effect and conveyed together with the fluid flow in the state of the entrained flow. Secondly, this means that the passivation device provides a fluid flow that contains a suitable passivating agent and whose composition enables a chemical reaction. Furthermore, an energy supply device is used to apply energy, for example to start and/or accelerate the reaction.

Optionally, the passivation device 1 comprises at least one sensor that detects a pressure and/or a temperature and/or a chemical composition (not shown in FIG. 1). The at least one sensor can, for example, be arranged in such a way that it determines the properties of the fluid in the conveying line 5. Alternatively or in addition, the at least one sensor can also be arranged in the outlet region 3 and/or in the fluid supply 4 and/or in the optional catchment 80. Preferably, the temperature is measured at least in the outlet region 3 or at the end of the conveying line 5 adjoining it and in the region of the end of the conveying line 5 opposite the outlet region 3, for example in order to monitor the entrained flow and the temperature conditions favorable for passivation in the entire region of the entrained flow, i.e. in the conveying line 5.

For example, a sensor can be used to monitor whether the properties of the fluid flow are suitable for the operation of the ejector and for the formation of an entrained flow. Alternatively or in addition, a sensor can also be used to monitor whether suitable conditions (e.g. with regard to passivating agent concentration, temperature and/or pressure) are present for a desired chemical reaction between the passivating agent and the filter residue. Controlled by signals output by such a sensor, the temperature, pressure and quantity of a passivating agent in the region of the filter device in which a chemical reaction is desired can be regulated, for example.

Optionally, the conveying line 5 comprises at least one cross-sectional constriction. This will be discussed in more detail in connection with the second exemplary embodiment.

### Second Exemplary Embodiment

The passivation device 1 according to the second exemplary embodiment is shown in FIG. 3.

The components and properties of the passivation device 1 according to the second exemplary embodiment that correspond to those of the passivation device 1 according to the first exemplary embodiment are not described separately below. With regard to the similarities, reference is made to the above description of the first exemplary embodiment. The following description is restricted to the differences. Corresponding components of the passivation device 1 of the first and second exemplary embodiments are also designated with the same reference numbers. All those components and properties of the filter device 1 that are described as optional features for the first exemplary embodiment are also optional features for the second exemplary embodiment.

The passivation device 1 according to the second exemplary embodiment differs from the passivation device 1 according to the first exemplary embodiment in particular in the design of the outlet region and the fluid supply. According to the second exemplary embodiment, no ejector is provided for sucking the filter residue out of the filter device 10. According to the second exemplary embodiment, the gravitational force acting on the filter residue in the filter device 10 causes it to enter the outlet region 3′ and to be conveyed through the conveying line 5 by means of the fluid flow entering the outlet region 3′ through the fluid supply 4′.

The outlet region 3′ is designed, for example, as a chamber to which the fluid supply 4′ and the conveying line 5 are connected, so that the fluid flow can pass through the chamber. The chamber can be connected or is connected directly or indirectly via a pipe, a line, etc. to an outlet opening through which filter residue can escape from the filter device 10.

Optionally, the conveying line 5 comprises a cross-sectional constriction 511. The cross-sectional constriction 511 can be seen in the enlargement of the section of the conveying line 5 circled with a dashed line shown in the lower part of FIG. 3. In FIG. 3, the cross-sectional constriction 511 is arranged at a distance from the outlet region 3′. However, the cross-sectional constriction 511 can also be arranged at a different position on the conveying line 5, for example closer to the outlet region 3′, in particular at a position adjacent to the outlet region 3′. The conveying line 5 can also comprise several cross-sectional constrictions.

The cross-sectional constriction 511 accelerates the fluid flowing through the conveying line 5. This can, for example, cause particle agglomerates contained in the filter residue to break up. This is symbolized in the enlargement shown in FIG. 3 by the fact that larger solid particles are depicted in the conveying line 5 upstream of the cross-sectional constriction 511 than downstream of the cross-sectional constriction 511.

### Third Exemplary Embodiment

The passivation device 1 according to the third exemplary embodiment is not shown in the figures.

Apart from the outlet region, fluid supply and fluid discharge, the third exemplary embodiment corresponds to the first exemplary embodiment. The components and properties of the passivation device 1 according to the third exemplary embodiment that correspond to those of the passivation device 1 according to the first exemplary embodiment are not described separately below. With regard to the similarities, reference is made to the above description of the first exemplary embodiment. The following description is restricted to the differences. All those components and properties of the filter device 1 that are described as optional features for the first exemplary embodiment are also optional features for the third exemplary embodiment.

According to the third exemplary embodiment, the outlet region, the fluid supply and the fluid discharge are configured as a venturi nozzle or as components of a venturi nozzle. Unlike in the first exemplary embodiment, the suction of filter residue from the filter device 10 is thus not by means of an ejector but by means of a venturi nozzle.

In further exemplary embodiments, other devices are used instead of or in addition to an ejector or venturi nozzle in order to effect suction of filter residue into the fluid flow.

### Further Exemplary Embodiments of the Passivation Device According to the Invention

Further exemplary embodiments of the passivation device 1 according to the invention arise, for example, in that instead of the energy supply device 70 of the exemplary embodiments described above or in addition to such an energy supply device 70, an energy supply device 70′ is provided which is configured and arranged to introduce energy into the region of the fluid discharge 5. The energy supply device 70′, which is optional in the exemplary embodiments described above, is shown in FIGS. 1 and 2.

Further exemplary embodiments of the passivation device 1 according to the invention arise, for example, in that instead of the energy supply device 70, 70′ of the exemplary embodiments described above or in addition to such an energy supply device 70, 70′, an energy supply device 70″ is provided that is configured and arranged to introduce energy into the region of the outlet region 3, 3′. The energy supply device 70″, which is optional in the exemplary embodiments described above, is shown in FIGS. 1 and 2.

The passivation device 1 according to the various exemplary embodiments can thus have one energy supply device or several energy supply devices.

Further exemplary embodiments of the passivation device 1 according to the invention arise, for example, in that instead of a passivating agent supply for feeding the passivating agent into the fluid supply 4, 4′ or in addition to such a passivating agent supply, a passivating agent supply is provided for feeding the passivating agent into the outlet region 3, 3′.

Further exemplary embodiments of the passivation device 1 according to the invention arise, for example, in that instead of a passivating agent supply for feeding the passivating agent into the fluid supply 4, 4′ and/or the outlet region 3, 3′ or in addition to such a passivating agent supply, a passivating agent supply is provided for feeding the passivating agent into the fluid discharge 5.

Further exemplary embodiments of the passivation device 1 according to the invention arise, for example, in that the at least one cross-sectional constriction 511 of the conveying line described specifically in connection with the second exemplary embodiment as an optional feature is implemented in the passivation device 1 of another exemplary embodiment.

### Exemplary Embodiments of the Filter System According to the Invention

Exemplary embodiments of the filter system 100 according to the invention comprise a passivation device 1 according to one of the embodiments described above and a filter device 10, wherein the passivation device 1 is coupled or can be coupled to the filter device.

The filter system 100 according to a first group of exemplary embodiments is shown in FIGS. 1 and 3. With regard to the passivation device 1 (area outlined with a dashed line), it is referred to the above description of the individual exemplary embodiments.

The passivation device 1, the filter device 10 and the filter system 100 as a whole are shown in FIGS. 1 and 3 as well as in FIGS. 4 to 9 in a possible operating position. Herein, the passivation device 1 is coupled to a filter device 10 and arranged in such a way that the passivation of filter residue is possible. The filter device 10 is arranged in such a way that, on the one hand, a process gas (raw gas) can be filtered by means of the filter device 10 and thereby cleaned of solids carried along in the process gas, and that, on the other hand, filter residue can exit the filter device 10 and enter the passivation device 1.

In addition to the passivation device 1, the filter system 100 comprises a filter device 1. The filter device 1 comprises a filter chamber 11 formed by a filter chamber wall 12, in which at least one filter element 20 is arranged. By way of example, FIGS. 1 and 3 show six filter elements 20 arranged in the filter chamber 11. The filter chamber 11 has a process gas inlet (not shown in FIGS. 1 and 3) and a process gas outlet (not shown in FIGS. 1 and 3), wherein the process gas inlet, the process gas outlet and the at least one filter element 20 are arranged such that a process gas that enters the filter chamber 10 via the process gas inlet and exits the filter chamber again via the process gas outlet is filtered by means of the at least one filter element 20. For example, the process gas inlet and the process gas outlet can be openings in the filter chamber wall 12, to which corresponding process gas lines are connected. By filtering the process gas, the solids carried along by the process gas are at least partially separated by being retained by the at least one filter element 20. The retained solids remain at least initially on the at least one filter element 20. The retained solids are generally also referred to as “filter residue”.

A region inside the filter chamber 10, which is arranged below the at least one filter element 20, is configured to receive filter residue that is detached from the at least one filter element or becomes detached from it. This means that, in the simplest case, this filter residue falls into this region. The region is preferably a collecting region 13, in which a certain amount of filter residue can be collected before it enters the passivation device 1.

Here, detachment can take place, for example, by the effect of gravity. An optional detachment device (not shown in FIGS. 1 and 3) can be provided to effect or expedite detachment. The detachment device can, for example, be configured to detach the filter residue adhering to the at least one filter element 20 by means of the action of gas. In doing so, it is preferable to interrupt the filtering of the process gas from time to time and to conduct a gas through the at least one filter element in the direction opposite to the direction of flow of the process gas during its filtering. To detach filter residue, the gas is preferably passed through the at least one filter element 20 in an intermittent manner. However, detachment is not limited to the procedure described above, but can also be carried out in other ways, for example by blowing, sweeping, scraping, shaking off, etc. A combination of several techniques for detachment is also possible. If the detachment technique used permits, filtering of the process gas can be continued by means of a filter element 20 while filter residue is detached from the same. If several filter elements 20 are provided, the detachment of filter residue from two different filter elements 20 can be carried out simultaneously or one after the other.

The fluid supply 4, 4′ of the passivation device 1 is connected to an external fluid source, so that fluid from outside the filter system 100 can be fed into the fluid supply 4, 4′. The fluid that is supplied to the outlet region 3, 3 through the fluid supply 4, 4′ can, for example, be taken from a provided fluid reservoir 90 (e.g. compressed gas storage in the form of a pressurized gas cylinder or the like), as already mentioned in connection with the above description of the passivation device. For this purpose, a fluid connection 91 is provided between the fluid supply 4 and the fluid reservoir 90.

Preferably, the lower region of the filter chamber or the collecting region 13 has a downwardly tapering wall and an outlet through which filter residue can exit the filter chamber 10. Such a collecting region 13 is shown in FIGS. 1 and 3. Optionally, a conveying device 14 is provided in the collecting region, which causes or supports the movement of the filter residue in the direction of the outlet, in particular if the inclination of the collecting chamber wall is relatively flat, so that the filter residue may not move reliably in the direction of the outlet by means of gravity. The conveying device can, for example, comprise a fluidizing plate provided in the wall.

Optionally, the filter device 10 has a collecting chamber 15 that is arranged between the filter chamber 11 and the passivation device 1 and in which filter residue can be collected.

Preferably, the individual components of the system 100 are configured and arranged such that the passivation device and an optional collecting chamber 15 are arranged in a space-saving manner at least partially below the filter chamber, as shown in FIGS. 1 and 3. Preferably, furthermore, the individual components of the system 100 are configured and arranged in such a way that an optional catchment 80 passivation device and an optional collecting chamber 15 are arranged in a space-saving manner at least partially below the filter chamber, as shown in FIGS. 1 and 3.

Optionally, the filter device 1 comprises at least one sensor that detects a pressure and/or a temperature and/or a chemical composition. FIGS. 1 and 3 show, by way of example, an oxygen sensor 151, a temperature sensor 152 and a pressure sensor 153, which can be used to detect the oxygen concentration, the temperature and the pressure in the collecting chamber 15. These sensors 151, 152, 153 can be used, for example, to collect measured values which can be used to draw conclusions about the risk of ignition of the filter residue in the collecting region 15 and the possible need for countermeasures such as a supply of inert gas. Alternatively, such sensors can, for example, be arranged in such a way that they collect measured values for the interior of the filter chamber 11.

Optionally, the filter device 1 comprises at least one filling level sensor (not shown in FIGS. 1 and 3) with which the filling level of the filter residue in the filter chamber 11 and/or in the optional collecting chamber 15 can be measured.

### Further Exemplary Embodiments of the Filter System According to the Invention

Further exemplary embodiments of the filter system 100 according to the invention result, for example, from modifications of the exemplary embodiments described above. In further exemplary embodiments, at least part of the fluid that is supplied to the outlet region 3, 3 through the fluid supply 4, 4′ is drawn from the filter chamber 11. The fluid drawn from the filter chamber 11 and fed into the fluid supply 4, 4′ is clean gas, i.e. process gas that has already been filtered by means of the at least one filter element 20. Otherwise, these further exemplary embodiments correspond to the exemplary embodiments described above.

Further exemplary embodiments of the filter system 100 according to the invention result, for example, from modifications of the exemplary embodiments described above. In further exemplary embodiments, at least part of the fluid that is supplied to the outlet region 3, 3 through the fluid supply 4, 4′ is extracted from a location on the clean gas side of the process gas circuit. For example, the fluid can be taken from a buffer tank, which provides fluid for cleaning the at least one filter element 20 by means of a pressurized gas surge. Here, the fluid available in the buffer tank can, for example, already have the pressure required to operate the filter system, so that an additional compression device can be dispensed with.

The filter system 100 according to the further exemplary embodiments is shown by way of example in FIGS. 4 and 5. The exemplary embodiments shown therein are modifications of the exemplary embodiments shown in FIGS. 1 and 3.

The filter system 100 comprises a line 92 through which clean gas is extracted from the filter chamber 11 and fed into the fluid supply 4, 4′. For this purpose, a fluid conveying device 93 is provided, which conveys the clean gas from the filter chamber 11 into the fluid supply 4, 4′. The fluid conveying device 93 can, for example, be a blower or a compressor.

FIGS. 4 and 5 show a passivating agent supply 6 through which passivating agent (for example oxygen) is fed into the line 92. The passivating agent supply 6 is connected, for example, to a passivating agent reservoir (not shown in FIGS. 4 and 5). Passivating agent can also be fed at another point as described above, for example in the area of the fluid supply 4, 4′ of the outlet region 3, 3′, the fluid discharge 5. Several passivating agent supplies can also be provided in order to supply passivating agent at different points. A passivating agent supply can also be dispensed with if the process gas already contains passivating agent. For example, it is possible that the process gas contains oxygen, which leads to effective oxidation of particles contained in the filter residue by supplying energy in the passivation device. In practice, the process gas could, for example, have an oxygen content of less than 1.3% by volume. An oxygen content in the low percentage range, in the tenths of a percent range or below can be partially acceptable for the additive manufacturing process. However, such an oxygen content may be partially sufficient for passivation, especially if passivation is improved by applying energy and/or breaking up agglomerates.

The filter system 100 according to further exemplary embodiments corresponds to the exemplary embodiments described above with the difference that it comprises at least two filter devices 10. In addition, it comprises a transport device 200 that transports the filter residue from the individual filter devices 10 into the passivation device 1, for example via lines 201. The transport device 200 is, for example, a suction device. An example of such a filter system 100 is shown in FIG. 6 with two filter devices 10-1 and 10-2. The filter system 100 can also comprise more than two filter devices. The at least two filter devices are preferably assigned to different devices for the additive manufacturing of three-dimensional objects (e.g. different systems for selective laser melting or laser powdered fusion).

The filter system 100 according to further exemplary embodiments corresponds to the exemplary embodiments described above, wherein it also comprises at least two filter devices 10. The passivation device 1 is coupled directly or indirectly to at least one of the filter devices, as already described above. In addition, the filter system 100 comprises a transport device 200 that transports the filter residue from the individual filter devices 10, which are not directly or indirectly coupled to the passivation device 1, into the passivation device 1, for example via lines 201. The transport device 200 is, for example, a suction device. By way of example, such a filter system 100 is shown in FIG. 7 with two filter devices 10-1 and 10-2. The filter system 100 can also comprise more than two filter devices. The at least two filter devices are preferably assigned to different devices for the additive manufacturing of three-dimensional objects (e.g. different systems for selective laser melting or laser powdered fusion).

The filter system 100 according to further exemplary embodiments corresponds to the exemplary embodiments described above, wherein it also comprises at least two filter devices 10. The passivation device 1 is coupled directly or indirectly to at least one of the filter devices, as already described above. In addition, the filter system 100 comprises a transport device 200 that transports the filter residue from the individual filter devices 10, which are not directly or indirectly coupled to the passivation device 1, into the collecting chamber or the filter chamber of at least one filter chamber 10, which is directly or indirectly coupled to the passivation device 1, for example via lines 201. The transport device 200 is, for example, a suction device. An example of such a filter system 100 is shown in FIG. 8 with two filter devices 10-1 and 10-2. The filter system 100 can also comprise more than two filter devices. The at least two filter devices are preferably assigned to different devices for the additive manufacturing of three-dimensional objects (e.g. different systems for selective laser melting).

A suction device that serves as a transport device 200 in the aforementioned sense can be realized, for example, by arranging a blower at the outlet of a filter device or a line connected to the outlet of a filter device or the outlets of several filter devices. Alternatively or in addition, pneumatic conveying is possible, for example by means of an ejector instead of a blower.

Further exemplary embodiments of the filter system 100 according to the invention arise, for example, in that in the exemplary embodiments described above, a filter residue conveyor is provided in the region of the outlet of the filter device 10, through which filter residue reaches the outlet region 3, 3′, in order to effect or expedite the transport of the filter residue into the outlet region 3, 3′. A filter residue conveyor can in particular be advantageous in exemplary embodiments in which no or no high suction pressure is generated by the conveyor device.

### Exemplary Embodiments of the Device for Additive Manufacturing of Three-Dimensional Objects According to the Invention

In exemplary embodiments of the device for additive manufacturing of three-dimensional objects according to the invention arise in that a device for additive manufacturing (e.g. a laser sintering system) having a process chamber and a process gas conveying device is equipped with the filter system 100 according to the invention in accordance with one of the above exemplary embodiments, so that the filter device 10 and the passivation device 1 form part of the device for additive manufacturing of three-dimensional objects.

The device shown as an example in FIG. 9 according to an exemplary embodiment is a laser sintering or laser melting device 101. To build up an object 102, it comprises a process chamber 103 with a chamber wall 104.

A container 105 open to the top and having a container wall 106 is arranged in the process chamber 103. The upper opening of the container 105 defines a working plane 107, wherein the region of the working plane 107 located within the opening, which can be used for building the object 102, is referred to as the build area 108.

A support 110 that can be moved in a vertical direction V is arranged in the container 105, to which support a base plate 111 is attached that closes the container 105 to the bottom and thus forms its bottom. The base plate 111 can be a plate formed separately from the support 110, which is attached to the support 110, or it can be formed integrally with the support 110. Depending on the powder and process used, a building platform 112 as a building base on which the object 102 is built can also be attached to the base plate 111. However, the object 102 can also be built on the base plate 111 itself, which then serves as a building base. In FIG. 9, the object 102 to be formed in the container 105 on the building platform 112 is shown below the working plane 107 in an intermediate state with several solidified layers surrounded by unsolidified building material 113.

The laser sintering device 101 further comprises a storage container 114 for a building material 115 in powder form which can be solidified by electromagnetic radiation, and a recoater 116 movable in a horizontal direction H for applying the building material 115 within the build area 108. Transverse to its direction of movement, the recoater 116 preferably extends over the entire area to be coated.

Optionally, a radiant heater 117 is arranged in the process chamber 103, which serves to heat the applied building material 115. The radiant heater 117 can be an infrared heater, for example.

The laser sintering device 101 further comprises an exposure device 120 having a laser 121 which generates a laser beam 122 that is deflected by a deflection device 123 and focused on the working plane 107 by a focusing device 124 via a coupling window 125 that is attached at the top of the process chamber 103 in the chamber wall 104.

Furthermore, the laser sintering device 101 comprises a control unit 129, via which the individual components of the device 101 are controlled in a coordinated manner to carry out the building process. Alternatively, the control unit can be arranged partially or completely outside of the device. The control unit can include a CPU whose operation is controlled by a computer program (software). The computer program can be stored separately from the device on a storage medium from which it can be loaded into the device, in particular into the control unit.

During operation, in order to apply a powder layer, the support 110 is first lowered by an amount that corresponds to the desired layer thickness. The recoater 116 first moves to the storage container 114 and receives from it a quantity of the building material 115 that is sufficient to apply a layer. It then moves across the build area 108, where it applies building material 115 in powder form to the building base or an already existing powder layer and draws it out to form a powder layer. The application takes place at least across the entire cross-section of the object 102 to be produced, preferably across the entire build area 108, i.e. the area bounded by the container wall 106. Optionally, the building material 115 in powder form is heated to a working temperature by means of a radiant heater 117.

The cross-section of the object 102 to be produced is then scanned by the laser beam 122, so that the building material 115 in powder form is solidified at the locations that correspond to the cross-section of the object 102 to be produced. In this process, the powder grains are partially or completely melted at these locations by means of the energy introduced by the radiation, so that after cooling they are present joined together as a solid body. These steps are repeated until the object 102 is completed and can be removed from the process chamber 103. Several three-dimensional objects 102 can also be produced simultaneously in the manner described.

Additive manufacturing takes place in the process chamber 103. The process gas conveying device 136, which is for example a blower, serves to convey a process gas flowing through the process chamber 103 from a process chamber inlet 132 to a process chamber outlet 134. The flow of the process gas through the process chamber 103 is schematically shown in FIG. 9 and provided with the reference sign 133. Preferably, the process gas is at least partially circulated, i.e. at least part of the process gas flowing through the process chamber outlet 134 is supplied back to the process chamber 103 through the process chamber inlet 132 after it has been filtered by the filter device 10 of the filter system 100. FIG. 9 shows such a process gas circuit, with the flow direction being symbolized by arrows.

The process chamber 103 is connected to the filter system 100 in such a way that process gas exiting the process chamber 103 through the process chamber outlet 134 is supplied into a process gas inlet 100-1 of the filter device 10. A line 135 is provided for this purpose, for example. In the case of recirculation of the process gas, a process gas outlet 100-2 of the filter device 10 is also connected to the process chamber inlet 132. A line 135 is provided for this purpose, for example. A process gas conveying device 136 can be provided, for example, between the process gas outlet 100-2 and the process chamber inlet 132 and/or between the process chamber outlet 134 and the process gas inlet 100-1. Preferably, the process gas conveying device 136 is arranged between the process gas outlet 100-2 of the filter device 10 and the process chamber inlet 132, because in this case the process gas conveying device 136 conveys clean gas, which reduces the risk of contamination of the process gas conveying device 136. This arrangement of the process gas conveying device 136 is shown in FIG. 9.

As an alternative to the described line 135 or a section thereof, the process chamber 103 and the filter chamber 11 can be connected such that the process chamber outlet 134 is directly connected to the process gas inlet 100-1 of the filter device 10 and/or such that the process chamber inlet 132 is directly connected to the process gas outlet 100-2 of the filter device 10.

Process gas before filtering is generally also referred to as “raw gas”, while process gas after filtering is generally also referred to as “clean gas”. That is, raw gas flows during operation from the process chamber outlet 134 into the process gas inlet 100-1 of the filter device.

Although the exemplary embodiments of the device for additive manufacturing are described using a selective laser sintering or laser melting device, they are not limited to selective laser sintering or laser melting. It can be applied to any method for generatively producing a three-dimensional object by layer-wise applying and selectively solidifying a building material.

For example, the exposure device can comprise one or more gas or solid-state lasers or any other type of laser such as laser diodes, in particular VCSEL (Vertical Cavity Surface Emitting Laser) or VECSEL (Vertical External Cavity Surface Emitting Laser), or a row of such lasers. In general, any device that can be used to selectively apply energy as wave or particle radiation to a layer of the building material can be used as an exposure device. Instead of a laser, for example, another light source, an electron beam or any other source of energy or radiation suitable for solidifying the building material can be used. Instead of deflecting a beam, exposure with a movable row exposure device can also be used. The invention can also be applied to selective mask sintering, in which an extended light source and a mask are used, or to high-speed sintering (HSS), in which a material that increases (absorption sintering) or decreases (inhibition sintering) the radiation absorption at the respective locations is selectively applied to the building material and then exposed non-selectively over a large area or with a movable row exposure unit.

Various types of powder can be used as the building material, in particular metal powder, plastic powder, ceramic powder, sand, filled or mixed powders. It is preferable to use the device for additive manufacturing according to the invention with metal powder as the building material, in particular with a metal powder which tends to form condensates, such as titanium powder or titanium-containing powder.

During operation of the passivation device 1 according to the invention in accordance with one of the exemplary embodiments described above, for example, the method for passivating according to the invention (hereinafter also referred to as “passivation method”) is carried out.

Filter residue that emerges from a filter device 10 is supplied to an outlet region 3, 3′ (step A). This is preferably done by suction from the filter device, for example by means of an ejector.

A fluid flow is supplied into the outlet region 3, 3′ (step B). As a result, the fluid flow is loaded with the filter residue. This means that the fluid flow captures the filter residue and transports it in the flow direction. In other words, the fluid flow carries the filter residue with it.

The fluid flow loaded with the filter residue is discharged from the outlet region 3, 3′ (step C).

Preferably, the filter residue is supplied into the outlet region 3, 3′ and the fluid flow is loaded with the filter residue in that the filter residue is sucked off as a result of the fluid flow and is thus included in the fluid flow.

Supplying the filter residue into the outlet region 3, 3′, loading the fluid flow with the filter residue and discharging it from the outlet region 3, 3′ is preferably carried out using an ejector. In doing so, the fluid flow is first fed into the ejector as a motive fluid. This creates a suction effect directed towards the filter device 10, by which filter residue is sucked in and enters the ejector. The region of the ejector into which the filter residue enters is therefore the outlet region 3. The fluid flow loaded with the filter residue is subsequently ejected from the ejector.

In the course of the passivation method, energy is applied to the fluid flow (step D). Energy can be applied:
(a) upstream of the outlet region, i.e. before the fluid flow is supplied into the outlet region 3, 3′, for example in the fluid supply 4, 4′,
(b) at the place where the fluid flow enters the outlet region 3,3′, i.e. during the supply of the fluid flow into the outlet region 3,3′,
(c) in the outlet region 3, 3′, i.e. while the fluid flow is passing through the outlet region 3, 3′,
(d) at the place where the fluid flow exits the outlet region 3,3′, i.e. during the discharge of the fluid flow from the outlet region 3,3′,
(e) downstream of the outlet region, i.e. after the fluid flow has been discharged from the outlet region 3, 3′, for example in the conveying line 5.

The application of energy can also take place simultaneously or at different times or at several locations, i.e. any combination of the above-mentioned possibilities (a) to (e) is possible. In other words, step D can take place at any location before, after and during the sequence of steps A to C.

### Energy is Preferably Applied by Heating.

The fluid flow used is either a fluid flow of a fluid comprising a passivating agent in step A. Or the passivating agent is added to the fluid in a further step (step E), i.e. the passivating agent is added to the fluid flow. It is also possible that the fluid contains passivating agent from the beginning, but further passivating agent is added to it during the passivation process. Step E can take place-if it is carried out-:
(i) upstream of the outlet region, i.e. before the fluid flow is supplied into the outlet region 3, 3′, for example by supplying the passivating agent into the fluid supply 4, 4′,
(ii) at the place where the fluid flow enters the outlet region 3,3′, i.e. during the supply of the fluid flow into the outlet region 3,3′,
(iii) in the outlet region 3,3′, for example by supplying the passivating agent into the outlet region 3,3′,
(iv) at the place where the fluid flow exits the outlet region 3,3′, i.e. during the discharge of the fluid flow from the outlet region 3,3′,
(v) downstream of the outlet region, i.e. after the fluid flow has been discharged from the outlet region 3, 3′, for example by supplying the passivating agent into the conveying line 5.

Addition of the passivating agent to the fluid can also take place at the same time or at different times or at several locations, i.e. any combination of the above options (i) to (v) is possible.

The filter residue is at least partially passivated in the entrained flow by a chemical reaction with the passivating agent (step F). This is referred to as “partial passivation” if only some of the particles of the filter residue react chemically with the passivating agent and/or if only some of the material of the particles that are passivated, which is basically reactive with respect to the passivating agent, is chemically converted.

Preferably, an oxidizing agent capable of at least partially oxidizing the filter residue is used as the passivating agent, more preferably the passivating agent comprises oxygen, further preferably the passivating agent is oxygen.

In particular, the fluid forming the fluid flow is an inert gas, for example nitrogen and/or argon, which contains O₂ or to which O₂ is added. The addition can be carried out, for example, by adding pure oxygen gas or a mixture containing oxygen gas (e.g. air). Preferably, the amount of O₂ added to the fluid flow is adjustable and/or at least 0.01% by volume and/or at most 20.8% by volume. In many cases, for reasons of fire and explosion safety, it has proven to be favorable to adjust the O₂ content so that it is below the limiting oxygen concentration, preferably at least 1%, more preferably at least 2%, further preferably at least 3% below the limiting oxygen concentration.

FIG. 10 graphically shows an exemplary embodiment of the method. In this exemplary embodiment, addition to the fluid flow (step E) takes place before the fluid flow is supplied into the outlet region 3, 3′ (step B). In this exemplary embodiment, energy is applied after the fluid flow mixed with the filter residue has left the outlet region 3, 3′. In this exemplary embodiment, the chemical reaction for passivation is initiated by the application of energy. Steps A, B, C are shown as consecutively performed steps because they can have this sequence for a certain amount of filter residue and the part of the fluid flow that transports this filter residue. Preferably, however, the passivation method is carried out continuously, so that fluid is continuously supplied into and discharged from the outlet region 3, 3′ over at least a certain period of time, while filter residue is fed into the fluid flow.

In the course of the passivation method, the following observation was made in at least some cases:

If the energy is supplied exclusively or predominantly to either the fluid or the filter residue by means of the energy supply device, equilibration of the energy occurs after the supply or after the fluid and filter residue come into contact, which occurs very quickly, for example in the range of less than one second or in the range of a few milliseconds at most, in particular in the case of small filter residue particles. This can be the case, for example, if first energy is added to the fluid flow before it reaches the outlet region and thus before it comes into contact with the filter residue.

The speed of equilibration depends, among other things, on the flow velocity of the fluid flow, its temperature and the particle diameter.

This is illustrated using an example in which an ejector, as described above for the first exemplary embodiment, is fed with argon via the fluid supply in the form of a conveying line with a circular cross-section and an inner diameter of 4 mm at a pressure of 2 bar (ejector inlet pressure) upstream of the ejector, a temperature of 250° C. and a flow rate of 3.8 L/s. Particles with different particle diameters enter the fluid flow in the ejector.

Here, the temperature of the particles Tₚ can be determined by measurement or calculated using the following equations (1) to (4). This is described in “ANSYS Fluent Theory Guide”, Release 15.0, November 2013. The time t=0 is the time at which the particles come into contact with the fluid flow. The temperature T_{∞} is the temperature of the fluid (K). Further, the variables represent the following variables:
mₚ—mass of a particle (kg)
Cₚ—heat capacity of a particle (J kg^{31 1} K⁻¹)
Aₚ—surface area of the particle (m²)
h—convective heat transfer coefficient (W m⁻² K⁻¹)
εₚ—emissivity of the particle (dimensionless)
σ—Stefan-Boltzmann constant (5.67×10⁻⁸ W m₋₂ K⁻⁴)
θ_{R}=(G/_{4σ})—radiation temperature (K), wherein G is the incident radiation (W/m²)

$${m}_{p} {c}_{p} \frac{{dT}_{p}}{dt} = {A}_{p} \{ - [ h + {ε}_{p} σ {T}_{p}^{3} ] {T}_{p} + [ {hT}_{∞} + {ε}_{p} {σθ}_{R}^{4} ] \} \qquad ( 1 )$$

For simplification, a sufficiently small time step Δt is selected for the calculation, resulting in

$${T}_{p} ( t + Δ t ) = {α}_{p} + [ {T}_{p} ( t ) - {α}_{p} ] {e}^{- {β}_{p} Δ t} \qquad ( 2 )$$

Here, the following applies:

$${α}_{p} = \frac{{hT}_{∞} + {ε}_{p} {σθ}_{R}^{4}}{h + {ε}_{p} σ {T}_{p}^{3} ( t )} \qquad ( 3 )$$

$$and$$

$${β}_{p} = \frac{{A}_{p} ( h + {ε}_{p} σ {T}_{p}^{3} ( t ) )}{{m}_{p} {c}_{p}} \qquad ( 4 )$$

Equation 1 is based on a thermal balance at the particle with the assumption that the particle temperature is constant over the radius. This assumption can be checked with the Biot number (Bi<0.1) and is generally given at least for smaller particles, which are relevant here.

The first term of the sum on the right-hand side of equation 1 describes the particle temperature change based on convection and thermal conduction. The second term describes the particle temperature change based on thermal radiation.

FIG. 11 shows a diagram showing the course of Tₚ as a function of time t for different particle diameters dₚ.

The time that the particles are in contact with the fluid until they leave the conveying line 5 again can be relatively short in some cases. For example, under the conditions mentioned above (ejector is fed with argon at 2 bar, 250° C. and 3.8 L/s via a conveying line with an inner diameter of 4 mm), it can be 10 ms or less if the conveying line is 1 m long. It can be seen from the diagram in FIG. 11 that in this case energy is only applied effectively to relatively small particles during conveying in the conveying line and the breaking up of particle aggregates into smaller particles often enables sufficient passivation or results in particularly effective passivation.

The breaking up of agglomerates can therefore be seen as a preferred optional further step in the passivation method.

For this purpose, for example, the fluid flow can be adjusted and/or controlled in such a way that particle agglomerates occurring in the filter residue are at least partially broken up. This effect can be achieved, for example, as an additional effect of using an ejector or a venturi nozzle to suck the filter residue out of the filter device 10, as there is a strong flow in an ejector or a venturi nozzle and often also downstream of it, which often leads to the breaking of agglomerates.

In order to promote the breaking of agglomerates, the fluid flow loaded with the filter residue can alternatively or additionally be guided through a cross-sectional constriction 511 of the fluid line 5.

In accordance with the results discussed above in connection with FIG. 11, the optional break-up is carried out in particular in such a way that the particles of the filter residue are present after break-up either in the form of primary particles or in the form of smaller agglomerates. In particular, this is understood to mean agglomerates having a secondary particle diameter corresponding to a maximum of 100 times, preferably a maximum of 50 times, more preferably a maximum of 10 times, in particular preferably a maximum of 5 times the primary particle diameter. Alternatively, this is understood to mean in particular agglomerates having a secondary particle diameter of maximum 200 μm, preferably maximum 100 μm, more preferably maximum 40 μm, even more preferably maximum 20 μm. In the example described, for example, comminution to a secondary particle diameter of 100 μm or less can be considered advantageous for the heating as effective as possible. In the case of other materials or fluid flow conditions, the value can also be higher, for example 200 μm.

Equations (1) to (4) above can be used, for example, to estimate whether particles of different diameters are heated quickly enough. In addition, the required length of the conveying line can be estimated, for example, if the particle size is known. For example, in order to heat particles with a diameter of 100 μm from room temperature to at least approximately 250° C., a time of around 250 ms is required according to this estimate. If the particles are then to be given 100 ms time for the chemical reaction at the temperature reached, this results in a desired dwelling time of 350 ms in the conveying line. If the average flow velocity is 10 m/s, a length of the conveying line of 3.5 m can be estimated.

During operation of the filter system 100 according to the invention in accordance with one of the exemplary embodiments described above, for example, the method according to the invention for filtering a process gas (hereinafter also referred to as “filtering method”) is carried out.

At least one filter element can optionally be coated with a filter auxiliary agent (optional step I).

A process gas is passed through at least one filter element 20 arranged in a filter chamber 11 of the filter device 10, wherein the process gas is filtered, i.e. at least partially cleaned of entrained solids (step II). For this purpose, the process gas is let into the filter chamber 11 via a process gas inlet and is let out of the filter chamber again via a process gas outlet, wherein it takes its path via the at least one filter element 20 or, in the case of several filter elements, via at least one of them. In particular, the process gas can be the process gas of a device for the additive manufacturing of three-dimensional objects, such as a system for selective laser sintering/melting.

The filtered solids remain on the at least one filter element 20, at least for the time being. The retained solids are generally also referred to as “filter residue”.

The filter element is cleaned or, in the case of several filter elements, at least a part thereof is cleaned (step III).

The filter residue either detaches itself from the at least one filter element 20 and the at least one filter element is thus cleaned. Or the filter residue is detached by a suitable measure and the at least one filter element is cleaned in this way. For detachment, for example, a pressurized gas surge can be passed through the at least one filter element 20 from time to time, the flow direction of which is opposite to the direction in which the process gas flows through the at least one filter element for filtering. Detachment can also be carried out by blowing, sweeping, scraping, shaking off, etc. A combination of several techniques for detachment is also possible.

The filtering of the process gas is optionally interrupted during the removal of the filter residue. Alternatively, the filtering of the process gas can be continued if this is permitted by the detachment technique used. Another possibility is that several filter elements 20 are provided and the filtering of the process gas is continued with one part of the filter elements 20 while another part is cleaned. It is also possible that several filter chambers 11 or several filter devices 10 are provided so that filtering can continue with a part of the filter chambers or filter devices while cleaning takes place in another part of the filter chambers 11 or filter devices 10.

The filter residue which has detached from the at least one filter element or which has been detached from it is optionally collected (step IV). This can be done, for example, by means of a collecting chamber into which the filter residue is introduced and in which it remains until it is subjected to the passivation process.

The filter residue is subjected to the passivation process according to the invention (step V).

FIG. 12 shows a graphic representation of an exemplary embodiment of the filtering method, wherein step D corresponds to the implementation of the passivation method as shown in FIG. 10.

The invention claimed is:

1. A passivation device for passivating a filter residue occurring in a filter device,
comprising
an outlet region which can be coupled or is coupled directly or indirectly to the filter device and is configured to receive filter residue from the filter device,
a fluid supply for supplying a fluid flow of a fluid, which can comprise a passivating agent, into the outlet region,
a fluid discharge for discharging the fluid flow and the filter residue from the outlet region, and
an energy supply device for applying energy to the fluid flow and/or the filter residue,
wherein the passivation device is configured and/or controllable to effect a chemical reaction between the filter residue and the passivating agent at least partially in the entrained flow.

2. The passivation device according to claim 1,
wherein the fluid discharge is designed as a conveying line, wherein the conveying line has at least in a region thereof, and along the entire length, an inner diameter of at least 20 mm and/or at most 40 mm, and wherein in each case, in the case of a non-circular cross-section of the conveying line, the diameter of a circular cross-section of the same area is considered as the inner diameter, and/or
wherein the fluid discharge is designed as a conveying line, wherein the ratio between the length of the conveying line and the inner diameter of the conveying line averaged over the length of the conveying line is at least least 100:1, and wherein, in the case of a non-circular cross-section of the conveying line, the diameter of a circular cross-section of the same area is considered as the inner diameter, and/or
wherein the fluid discharge is designed as a conveying line, and wherein the passivation device is configured and/or controllable in such a way that a dwelling time of the filter residue in the conveying line is at least 0.2 s and/or at most 0.3 s.

3. The passivation device according to claim 1,
wherein the energy supply device comprises a heating device configured to heat the fluid flow as it flows through the heating device, and/or
wherein the energy supply device is arranged such that the fluid flow is heated to a predefined minimum target temperature before it enters the outlet region, and/or
wherein the energy supply device is configured and arranged to supply energy to at least one element selected from the group consisting of the fluid supply, the outlet region and the fluid discharge in order to apply energy to the fluid flow.

4. The passivation device according to claim 1,
wherein the fluid supply comprises a nozzle that is configured and/or arranged such that the fluid flow directed through the nozzle is accelerated in such a way that a suction pressure is generated for conveying the filter residue from the filter device and a fluid present in the filter device into the outlet region, and
wherein the filter residue is conveyed out of the outlet region with the fluid flow through the fluid discharge,
wherein the nozzle is designed as an ejector nozzle or Venturi nozzle and/or
wherein the nozzle is configured to adjust a velocity and/or a diameter of the fluid flow passing through the nozzle.

5. The passivation device according to claim 1,
wherein the conveying line comprises a shut-off valve, and/or
wherein the conveying line is designed as a metal pipe having a wall thickness of at least 5 mm, and/or
wherein the line is thermally insulated.

6. The passivation device according to claim 5,
wherein the passivation device comprises a catchment for collecting passivated filter residue and the catchment is in fluid communication with the outlet region via the conveying line that is free from a shut-off valve, or via the conveying line when the shut-off valve is open.

7. The passivation device according to claim 1, further comprising a passivating agent supply for supplying the passivating agent,
wherein the passivating agent supply is configured and arranged to supply passivating agent to at least one element selected from the group consisting of fluid supply, outlet region and fluid discharge, and/or
wherein the passivating agent is an oxidizing agent that is adapted for at least partially oxidizing the filter residue,
wherein the oxidizing agent is oxygen, and wherein the passivating agent is supplied in the form of a mixture of oxygen and argon.

8. The passivation device according to claim 1,
further comprising a fluid reservoir containing a compressed gas storage containing a pressurized gas,
wherein the fluid supply provides a fluid connection between the fluid reservoir and the outlet region, and
wherein the fluid contained in the fluid reservoir at least partially comprises the passivating agent and/or wherein the passivating agent is at least partially fed by a passivating agent supply from a passivating agent reservoir and/or in the form of air from the atmosphere into the fluid supply and/or the fluid discharge and/or the outlet region.

9. The passivation device according to claim 8,
wherein the fluid supply and the fluid reservoir and the passivating agent reservoir are configured or are adapted or controllable, so that in the outlet region or a region of the fluid discharge as a fluid flow a gas flow is present that consists of a mixture of argon, and O₂ with an adjustable O₂ content and/or with an O₂ content in a range of least 1% by volume, and/or at most 5% by volume, and/or with an O₂ content below the limiting oxygen concentration at least 3% below the limiting oxygen concentration.

10. The passivation device according to claim 1,
wherein the fluid supply is connected to the filter chamber such that at least part of the filtered process gas is conveyed into the outlet region,
wherein the fluid supply comprises a blower.

11. A filter system, comprising:
at least one filter device, each comprising
a filter chamber,
at least one filter element arranged in the filter chamber and a collecting chamber coupled to the filter chamber, which can be separated from the filter chamber in a fluid-tight manner by a shut-off device, and
a passivation device according to claim 1 that is directly or indirectly coupled to the at least one filter device or connected to the at least one filter device by a transport device for transporting the filter residue.

12. The filter system according to claim 11,
wherein the filter chamber comprises a collecting region,
wherein the collecting region in an operating position is arranged below the at least one filter element,
wherein the collecting region comprises a downwardly tapering wall and leads to a filter chamber outlet connected to the passivation device or the collecting chamber, and/or
wherein a conveying device for conveying filter residue is provided at least in a subregion with a lower inclination to the vertical relative to other subregions,
wherein the conveying device comprises fluidizing plate, and/or one or more gas nozzles for introducing gas surges.

13. The filter system according to claim 11,
wherein the collecting region, is configured such that the passivation device and a collecting chamber comprised by the filter device can be arranged at least partially below the filter chamber in the operating position,
wherein a catchment comprised by the passivation device can be arranged at least partially below the filter chamber.

14. The filter system according to claim 11,
further comprising an application device for applying a filter auxiliary agent in powder form, to the at least one filter element and/or
further comprising a filling level sensor for measuring a quantity of filter residue detached from the at least one filter element collection region and/or in the collecting chamber.

15. The filter system according to claim 11,
wherein the filter system comprises exactly one filter device,
wherein the passivation device is directly or indirectly coupled to the filter chamber or to the collecting chamber.

16. The filter system according to claim 11,
comprising at least two filter devices and a transport device for transporting the filter residue from the at least two filter devices to the passivation device,
wherein the transport device is an ejector suction device.

17. The filter system according to claim 11,
comprising at least two filter devices, wherein the passivation device is directly or indirectly coupled to one of the filter devices, and
a transport device for transporting the filter residue from at least one other of the filter device to the passivation device,
wherein the transport device is an ejector suction device.

18. The filter system according to claim 11,
comprising at least two filter devices and a transport device for transporting the filter residue from at least one of the filter devices into the collecting chamber of at least one further filter device,
wherein the transport device is an ejector suction device.

19. A device for additive manufacturing of three-dimensional objects comprising:
a process chamber in which the additive manufacturing takes place,
a process gas conveying device for conveying a process gas flowing through the process chamber from a process chamber inlet to a process chamber outlet, the process gas conveying device being configured to effect the conveying between the process chamber inlet and the process chamber outlet at least partially in a circuit,
a filter system according to claim 10,
wherein the at least one filter chamber is arranged such that the process gas exiting the process chamber is filtered by the at least one filter element.

20. A system for additive manufacturing of three-dimensional objects comprising:
at least two devices for the additive manufacturing of three-dimensional objects, the devices each comprising a process chamber in which the additive manufacturing takes place, and a process gas conveying device for conveying a process gas flowing through the process chamber from a process chamber inlet to a process chamber outlet, wherein the process gas conveying device is in each case configured to effect the conveying between the process chamber inlet and the process chamber outlet at least partially in a circuit,
a filter system according to claim 16,
wherein one of the at least two filter devices is assigned or assignable to each additive manufacturing device.

21. A method for passivating a filter residue occurring in at least one filter device, comprising the steps of:
supplying filter residue that exits the at least one filter device into an outlet region,
supplying a fluid flow into the outlet region,
discharging the fluid flow loaded with the filter residue from the outlet region,
applying energy to the fluid flow, wherein the application of energy to the fluid flow takes place before supplying and/or during supplying the fluid flow into the outlet region and/or in the outlet region and/or during discharging and/or after discharging the fluid flow from the outlet region,
wherein a fluid flow of a fluid comprising a passivating agent is used as the fluid flow and/or a passivating agent is added to the fluid flow,
wherein the filter residue is at least partially passivated in the entrained flow by a chemical reaction with the passivating agent.

22. The method according to claim 21, wherein
the fluid flow loaded with the filter residue falls below the lower explosion limit, reaching at most 0.8 times the lower explosion limit, or
the fluid flow loaded with the filter residue exceeds the upper explosion limit, reaching at least 1.2 times the upper explosion limit.

23. The method according to claim 21,
wherein the fluid flow is supplied into the outlet region in such a way that a suction pressure is generated in the outlet region by a nozzle,
wherein the filter residue and a fluid present in the at least one filter device are sucked out of the at least one filter device into the outlet region by the suction pressure, and wherein the filter residue is conveyed with the fluid flow through a fluid discharge from the outlet region,
wherein a velocity and/or a diameter of the fluid flow passing through the nozzle are adjusted.

24. The method according to claim 21,
wherein the fluid flow is adjusted and/or controlled such that particle agglomerates occurring in the filter residue are broken up such that the filter residue after the break-up is present in the form of particles having a secondary particle diameter which corresponds to a maximum 5-fold primary particle diameter and/or a secondary particle diameter of maximum 100 μm,
wherein the break-up is effected by the particle agglomerates and the fluid flow encountering each other, and/or
wherein the particle agglomerates are broken up directly downstream of the nozzle and/or
wherein the particle agglomerates are broken up in a cross-sectional constriction of a conveying line.

25. The method according to claim 21,
wherein the fluid is discharged from the outlet region into a catchment by the fluid discharge and/or
wherein the chemical reaction takes place in the outlet region and/or during the discharge.

26. A method for filtering a process gas of a device for the additive manufacturing of three-dimensional objects,
comprising the steps:
coating at least one filter element with a filter auxiliary agent in powder form,
passing the process gas through the at least one filter element to filter out particles from the process gas,
cleaning the filter element or cleaning at least a part of two or more than two filter elements from the filter residue formed from filtered-out particles and the filter auxiliary agent,
collecting the filter residue and
passivating the filter residue according to a method according to claim 21.

27. The method according to claim 26,
wherein at least two filter elements, arranged in different filter chambers, are used,
wherein the cleaning of each of the at least two filter elements takes place at different times,
wherein a waiting time is maintained between two successive cleanings, and
wherein during the waiting time, the passivation step is carried out at least partially,
wherein the individual filter elements are cleaned one after the other in a predetermined sequence.
